(19) United States
(12) Patent Application Publication
(10) Pub. No.: US 2010/0241731 A1
(43) Pub. Date: Sep. 23, 2010

(54) METHOD FOR VIRTUALIZING INTERNET RESOURCES AS A VIRTUAL COMPUTER

(75) Inventors: Haikun Du, Lake Worth, FL (US); Zhihui Huang, Lake Worth, FL (US); Gang Xu, Lake Worth, FL (US)

Correspondence Address: MICHAEL J. BUCHENHORNER, 8540 S.W. 83 STREET, MIAMI, FL, 33143, US

(73) Assignee: Gladinet, Inc., Lake Worth, FL (US)

(21) Appl. No.: 12/725,434

(22) Filed: Mar. 16, 2010

Related U.S. Application Data
(60) Provisional application No. 61/160,965, filed on Mar. 17, 2009.

(51) Int. Cl. G06F 15/16; G06F 12/00

(52) U.S. Cl. 709/218; 711/114; 709/229; 711/E12.001; 715/733

(57) ABSTRACT

A system and method for presenting a representation of a remotely located storage resource includes: using a processor device for: receiving a first request from a user, said first request including an identification of the storage resource; authenticating the user request; virtualizing the storage resource by creating a node for presentation to the user, wherein said node represents the storage resource; presenting the node to the user; receiving a second request from the user for data stored in the storage resource represented by the node; retrieving the requested data from the storage resource; and presenting the requested data to the user on the node.

### CROSS-REFERENCE TO RELATED APPLICATIONS

This application is a non-provisional of, and claims the benefit of, commonly-owned and co-pending U.S. Provisional Patent Application No. 61/160,965, filed on Mar. 17, 2009.

### FIELD OF THE INVENTION

The invention disclosed broadly relates to the field of information processing systems, and more particularly relates to the field of cloud computing.

### BACKGROUND OF THE INVENTION

Many web applications/services have been developed since the inception of the Internet, and more and more are being developed. However, there are some problems that prevent these applications and services from being adopted to work cohesively together. Some online storage services can be difficult to use. Web browser are generally fairly easy to use but are limited in providing web storage. Web Applications are isolated because they are used in a proprietary web browser. There is no easy way to allow information to flow from one service provider to another.

Using a real-world example, assume website 1 is Amazon S3 (Amazon Simple Storage Service) by Amazon Web Services LLC. A user has a document in website 1. Now assume that website 2 is ZOHO (by ZOHO Corporation) and contains a web application such as ZOHO Writer. The problem is how to make ZOHO Writer modify the document served by Amazon S3 when by nature, there is no connection between the two providers. Doing this manually would require the following steps:

1. Download the file from Amazon S3 to your local desktop. 2. Manually upload the file to ZOHO Writer. 3. Use the ZOHO Writer web application to modify the file. 4. Download the modified file from ZOHO Writer. 5. Upload the modified file back up to Amazon S3.

People today are “plugged in” with so many devices (laptop, desktop at home, desktop at work, cell phone, personal digital assistant). These devices are often not within the same local area network (LAN) and use their own proprietary interfaces, making it difficult to combine and organize the multiple documents from the various devices.

There exists a need for a system and method to address the above-stated shortcomings of the known art.

### SUMMARY OF THE INVENTION

Briefly, according to an embodiment of the invention a computer-implemented method for virtualization of a remotely located storage resource includes steps or acts of: receiving a first request from a user, said request including an identification of the storage resource; authenticating the user request; virtualizing the storage resource by creating a node for presentation to the user, wherein said node represents the storage resource; presenting the node to the user; receiving a second request from the user for data stored in the storage resource represented by the node; retrieving the requested data from the storage resource; and presenting the requested data to the user on the node.

According to another embodiment of the present invention, a computer-implemented method for application virtualization includes steps or acts of: receiving a command from a user to open a file on a first website using an application from a second website that is different from the first website, said command including a location of the first website and a location of the second website; creating a global namespace for the user; and defining a generic application interface for the application, said interface including the following application settings: the location of the second website, a type of the application, and supported commands for the application. The method continues by virtualizing the application settings as a generic application object represented as an application node in the global namespace; retrieving the generic application object using a full path of the application in the global namespace; checking a configuration of the application by verifying the application settings; determining whether the application supports accessing the first website as defined by its uniform resource locator; using the uniform resource locator of the first website, invoking the web application using said uniform resource locator as one parameter as instructed by the application setting, wherein invoking the web application causes said application to execute using the file as input; and transmitting results of the execution of the file to the user.

According to another embodiment of the present invention, a system for virtualizing web applications and remotely located storage resources includes: a processor device; a memory with an operating system, an internet operating system, and at least one plug-in for implementing a generic interface between the user and the virtualized web applications; a peer to peer high speed channel to all devices in the internet operating system; and a presentation medium for facilitating a user interaction between the virtualized web applications and the virtualized storage resources.

### BRIEF DESCRIPTION OF THE DRAWINGS

To describe the foregoing and other exemplary purposes, aspects, and advantages, we use the following detailed description of an exemplary embodiment of the invention with reference to the drawings, in which:

FIG. 1 shows a screenshot of the start page, according to an embodiment of the present invention;

FIG. 2 shows a screenshot of the drive mapping page, according to an embodiment of the present invention;

FIG. 3 shows a screenshot of the mounting of a service provider into storage directory dialog, according to an embodiment of the present invention;

FIG. 4 shows a screenshot of the virtual drive, according to an embodiment of the present invention;

FIG. 5 shows a screenshot of the mounting and selection page for alternate online storage, according to an embodiment of the present invention;

FIG. 6 shows a screenshot of the virtual folder for the alternate online storage, according to an embodiment of the present invention;

FIG. 7 shows a screenshot of an online storage selection page, according to an embodiment of the present invention;

FIG. 8 shows a screenshot of the user-generated web albums shown as folders, according to an embodiment of the present invention;

FIG. 9 shows a screenshot of the online photos appearing as image files, according to an embodiment of the present invention;

FIG. 10 shows a screenshot of the Virtual Directory Manager mounting dialog, according to an embodiment of the present invention;

FIG. 11 shows a screenshot of the folders listed for the Virtual Directory Manager of FIG. 10, according to an embodiment of the present invention;

FIG. 12 shows a screenshot of a system tray application, according to an embodiment of the invention;

FIG. 13 shows a screenshot of the proprietary virtual drive, according to an embodiment of the present invention;

FIG. 14 shows a screenshot of the virtual directory access, according to an embodiment of the present invention;

FIG. 15 shows a screenshot of the Virtual Directory Manager for managing virtual directory information, according to an embodiment of the present invention;

FIG. 16 shows a screenshot of the drop-down menu for applications, according to an embodiment of the present invention;

FIG. 17 shows a screenshot of the menu selection for the menu of FIG. 16, according to an embodiment of the present invention;

FIG. 18 shows a screenshot of the Application Manager login page, according to an embodiment of the present invention;

FIG. 19 shows a screenshot of the system menu, according to an embodiment of the present invention;

FIG. 20 shows a screenshot of the mail application, according to an embodiment of the present invention;

FIG. 21 shows a screenshot of the document selection page, according to an embodiment of the present invention;

FIG. 22 shows a screenshot of a save feature;

FIG. 23 shows a screenshot of the Safe Card Manager, according to an embodiment of the present invention;

FIG. 24 shows a screenshot of the Task Manager, according to an embodiment of the present invention;

FIG. 25A shows a screenshot of the upgrade menu, according to an embodiment of the present invention;

FIG. 25B shows a screenshot of the version switch dialog box, according to an embodiment of the present invention;

FIG. 26 shows a screenshot of the login page, according to an embodiment of the present invention;

FIG. 27 shows a screenshot of a directory menu, according to an embodiment of the present invention;

FIG. 28 shows a screenshot of the Share Manager page, according to an embodiment of the present invention;

FIG. 29 shows a screenshot of the selection from Windows Explorer, according to an embodiment of the present invention;

FIG. 30 shows a screenshot of the Share Manager creation page, according to an embodiment of the present invention;

FIG. 31 shows a screenshot of the Share Manager transmittal page, according to an embodiment of the present invention;

FIG. 32 shows a screenshot of the virtual drive with the imported documents, according to an embodiment of the present invention;

FIG. 33 shows a screenshot of the share notification page, according to an embodiment of the present invention;

FIG. 34 shows a screenshot of the Virtual Directory Manager, according to an embodiment of the present invention;

FIG. 35 shows a screenshot of the virtual drive, according to an embodiment of the present invention;

FIG. 36 shows a screenshot of the menu for adding a folder to the virtual drive, according to an embodiment of the present invention;

FIG. 37 shows a screenshot of the port map manager, according to an embodiment of the present invention;

FIG. 38 shows a screenshot of the port configuration page, according to an embodiment of the present invention;

FIG. 39 shows a screenshot of the virtual drive as accessed from a desktop, according to an embodiment of the present invention;

FIG. 40 shows a screenshot of the virtual drive accessed via a web browser, according to an embodiment of the present invention;

FIG. 41 shows a screenshot of the menu selection from the virtual drive of FIG. 40, according to an embodiment of the present invention;

FIG. 42 is a high level flowchart of a processing flow according to an embodiment of the present invention;

FIG. 43 is a high level block diagram of a computer system in which the invention can be advantageously implemented;

FIG. 44 is a simplified depiction of application virtualization, according to an embodiment of the present invention;

FIG. 45 is a high level flow chart of a method for application virtualization, according to an embodiment of the present invention; and

FIG. 46 is a high level flow chart of processing path A from FIG. 45, according to an embodiment of the present invention.

While the invention as claimed can be modified into alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the scope of the present invention.

### DETAILED DESCRIPTION

We disclose an Internet Operating System (IOS) which provides the following benefits: A) virtualizes differing, remotely-located resources into generic resources; B) enables user interaction among various resources regardless of where these resources reside; C) central aggregation and management of personal, Internet, and local resources; and D) enabling differing presentations of the virtualized resources from any location.

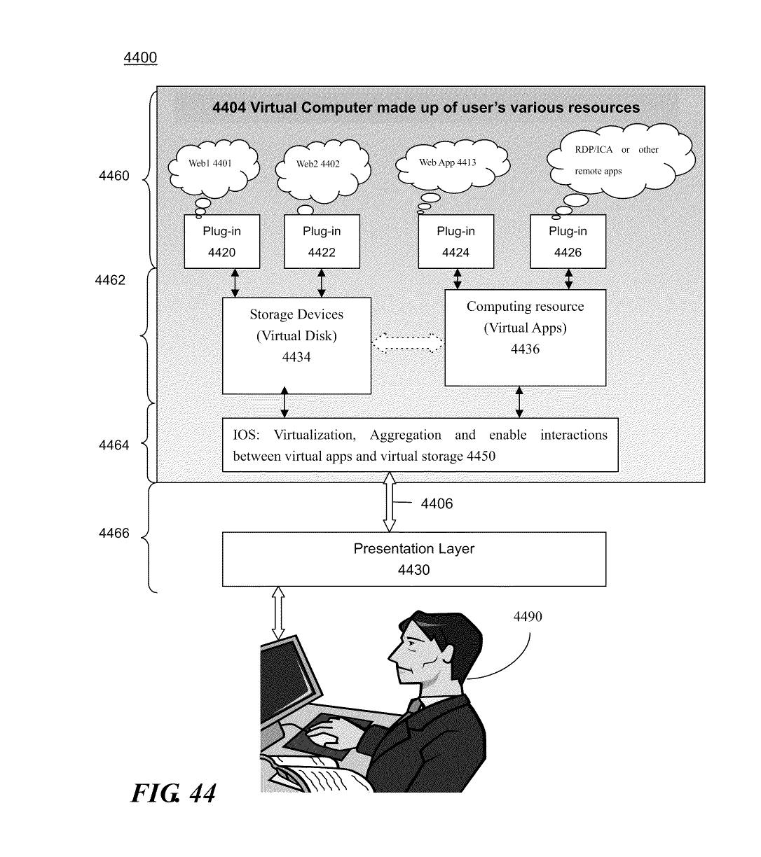

Referring now to the drawings and to FIG. 44 in particular, we illustrate the functionality that provides these four benefits. Many definitions of “virtualization” can be found in today's technology lexicon. For the purposes of this invention, we define the term “virtualize” to mean “create a virtual (simulated) version of a node on a user's device such that the virtual version behaves in the same manner as the actual node resident on a remote system.” The node can be all or a partition of a storage resource, an application, an application interface, an object, and/or a document. Also for purposes of this invention, we define “remotely located” to mean those resources which are separated by the Internet, including being separated by firewalls.

Each of the four benefits to be described herein correspond to a layer of the virtualization diagram of FIG. 44, in order from top to bottom:

A. Virtualize Different Resources into Generic Resources.

In the top-most Virtualization Layer 4460, we employ plug-ins 4420, 4422, 4424, and 4426 to 1) virtualize remote storage services into generic storage interfaces and objects; and 2) virtualize application objects into generic applications. By generic we mean that the nodes are not specific to a local operating system (OS) so that they can be presented differently if need be (such as to present it to the local OS, or present it to a web page inside of a web browser.

In Storage Virtualization, various storage providers are virtualized as file system objects, and can be mounted as a virtual directory. Web application virtualization has two meanings 1) add thin proprietary web app layer to make it a generic Web Application that can be used by the Internet Operating System (IOS). It is represented as a web app file system object located under the web apps' virtual directory. 2) We generate public link, so that web apps can access local resources. This link is ticketed, and cannot be used by others. By ticketing, we mean the conventional meaning of link authentication for a session. It works as follows.

Assume we want to give ZOHO Writer, the ticket holder, a five-minute window for it to read a file called demo.txt where demo.txt is virtualized into the global namespace as /local_drive/dir1/dir2/demo.txt. To generate a public link, the local IOS agent will look into the file such as /local drive/dir1/dir2/demo.txt and translate it to the real physical file demo.txt. The local IOS agent will then talk to a service on a web server such as www.gladinet.com and tell the service that it needs to generate a ticket for five minutes for this file demo.txt. so that the service will record the request in a database, recording the time to expire, the file name, and the IP address where the request is coming from. The web service generates a ticket in some format such as a_long_string with_some_random_digits. Then the ticket can be translated into a public link such as http://www.gladinet.com/ticket/a_long_string_with_some_random_digits. Someone visiting this link will invoke the service on the web server; the web server does a database lookup and finds the IP address of the request it is coming from. The web server can then proxy the request back to the IOS agent running on that IP address through a peer to peer (P2P) method and retrieve the demo.txt file.

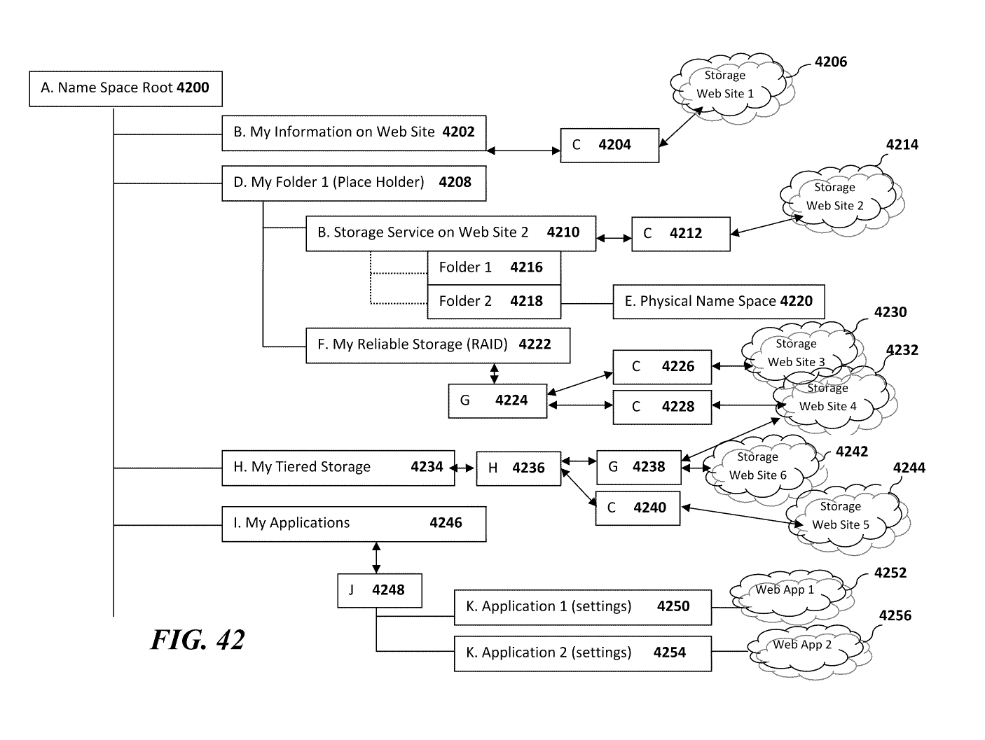

To virtualize an application we first need to define a generic application interface that includes the following information: a) the location (for example: http://docs.google.com, an IP address); b) the type of application (for example, a web application, native application, terminal server application, and so forth); and c) the supported method requested by the user (for example, open or save). Secondly, we need to use a plugin to implement the generic interface if the app itself doesn't have the interface. Thirdly, virtualize the settings above as a generic application object. The object becomes a node in the Global Namespace (please refer to FIG. 42).

An application object can live in the global namespace. For example /root/applications/google_docs.xml can be the virtual path to a file object. This file object contains the settings of the google_docs application. When someone makes a request to the IOS agent for this specific file, an XML file can be retrieved with the settings embedded inside the file. So in this manner the settings are virtualized into an XML file, address-able by the path /root/applications/google-docs.xml.

B. Enable Interaction Among Various Resources.

There is a tremendous amount and variety of resources that exist in the Internet today, but the utilization of these resources is quite low due to the lack of interaction among the resources. We address this problem in the Interaction Layer 4462 by virtualizing applications so that they are able to interact with virtualized storage objects in the global namespace defined in FIG. 42.

1) enabling interaction of physical resources such as personal computer (PCs) and handhelds by providing high speed peer to peer channels. We enable interaction of these resources even if they are located behind firewalls.

2) enabling interaction of various resources (local or online) by providing a thin virtualization layer. In one example of this layer, a Web Application from Web Site A can interact with a file located on Web Site B directly, even if the two websites had no knowledge of each other beforehand.

C. Central Aggregation and Management of Personal Resources.

In the IOS Layer 4464, we provide central profile functionality (a global namespace) to manage a user's resources either locally or located on the Internet, just like conventional operating systems manage local resources for the user. The aggregation of all resources belonging to the user is made up of Internet and local storage and computing resources, which can be published via a generic interface, thus the IOS functionality can be presented to the user as a) part of the desktop (desktop integration to extend existing desktop); b) WebTop; and c) third party integration. The centralized user profile management functionality is provided by:

1) geo-based profile management server—the profile is always locally stored.

2) virtual desktop—the product defines and maintains a virtual desktop or virtual pc, which represents all the apps (web, local) available to the user, and personal visual preferences;

3) virtual directory management—Most (if not all) resources belonging to the user can be mounted as a virtual directory, the user profile maintains all virtual directory mounted by the user, which is represented as a virtual drive.

4) unified contact management—a user's contacts can come from various sources, i.e., Facebook, Gmail, the product provides a unified way to manage/use all these contacts.

5) My Safe—central storage for user's secure data, such as passwords, account info;

6) Access user profile via an interface such as WebDav, providing an open interface for bi-directional third party integration.

7) Publish Share—User can create a share using local resource, the share can be accessed by others, even the resources located behind firewall/NAT, the share is ticketed, thus user can control who, when can access the share. Additionally, we provide the functionality to Send Share via system messages—sending a share directly to other IOS users. The user is able to import share as a Virtual Directory—The user of the product can import the share he received as virtual directory, and access it just like other virtual directory already exists, in a desktop environment, this share just become part of his local file system.

8) Single sign-on—We provide single sign on for all integrated storage and web apps using My safe functionality.

9) IOS Agent (Web Directory Integration)—The product works with a web directory service to provide semantic, organized internet service, this feature is called IOS agent service, for the first release, the agent only provides such service for web apps, we will extend this service in the following release.

10) Personal Agent to provide organized Internet service—Another reason that prevents the average user from utilizing the huge amount of available Internet resources better is that the useful information is almost always overwhelmed by the huge amount of unrelated information. This problem is not much improved even with the help of a search engine. ISO acts as personal agent interacts with Nextgate Web directory, or with other IOS instance to provide organized internet service.

D. Enabling Differing Presentations of the Virtualized Resources.

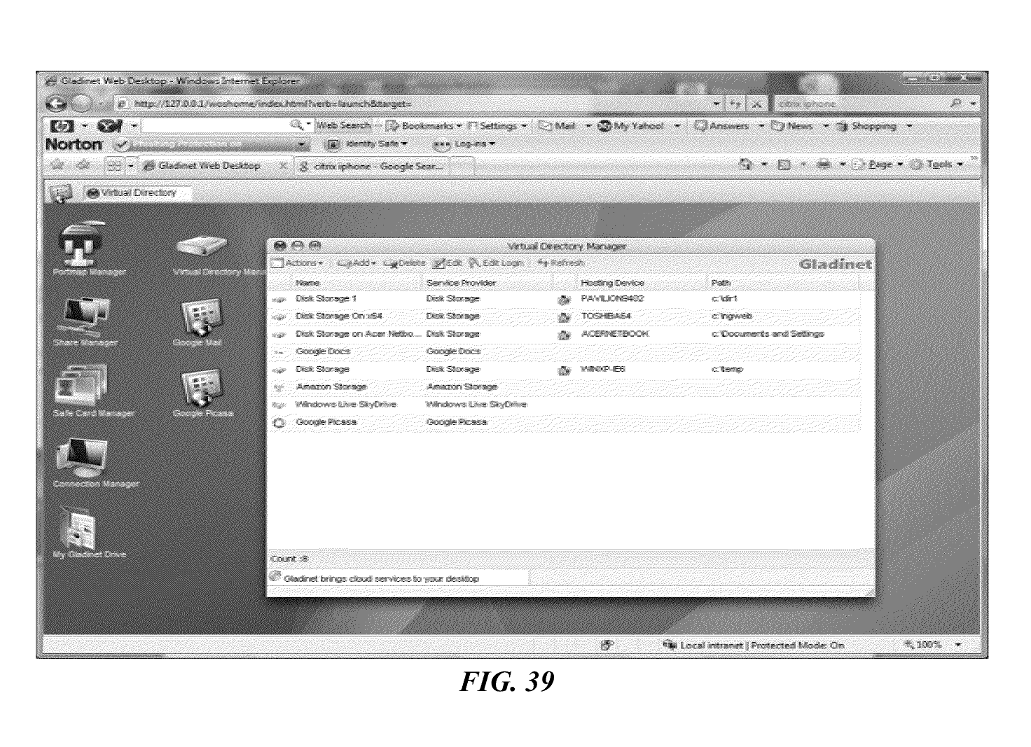

In the Presentation Layer 4466, we bind the virtual objects into a local presentation with a local app running on a local or network mapped drive. Alternatively, we can bind the virtual objects into a web presentation that can run from a web page (see the webtop example shown in FIGS. 39-41) or as a local native application. We can bind the storage into a file server for access by any standard file sharing protocol. A webtop is a desktop environment embedded in a Web browser. A virtual disk can be mapped as a local or network drive.

Alternatively, the storage can be presented on a File Server so that collaborators can access it through network file sharing protocols such as CIFS/SMB protocols by Microsoft Corporation. CIFS is short for Common Internet File System Protocol, a dialect of SMB (Server Message Block). Both SMB and CIFS are also available on VMS (Virtual Memory System), several versions of Unix, and other operating systems. Just like a conventional operating system (OS), the Internet OS requires a human-computer interface (i.e., a desktop for windows) to use the OS functionality. This product defines a virtual desktop/computer that can be represented to the user in various configurations to expose the functionality in a setting familiar to the user.

Feature List.

Peer to Peer high speed channel. The product provides high speed channel among all devices configured in the user's profile, the channel can be established above:

high speed TCP channel traversing a firewall;

bundled TCP links when UDP is not usable;

profile server forwarded channel (when firewall/NAT traversing is not available. The channel can automatically detect if the data can be compressed, and then turn on/off compression automatically.

The following are some of the features that directly take advantage of the high speed channel:

Port Map—map a remote port as a local port to use the channel, use one server as proxy, such as while in home, can use office machine as proxy to access resource that cannot be accessed directly from home.

RDP—automatically port map, remote in box behind firewall/Nat with better quality (similar in functionality to gotomypc and logmein).

Local storage based virtual directory. Access hard drive located on a box behind firewall/Nat with BT performance.

HTTP proxy—use any one machine as an http proxy, such as using home pc as http proxy to access website that cannot be accessed from office pc otherwise.

Multi-Directional Firewall

Installation—Installation is done through MSI packages. There are two MSI packages, one for 32-bit and one for 64-bit.

Descriptions of Various Screenshots.

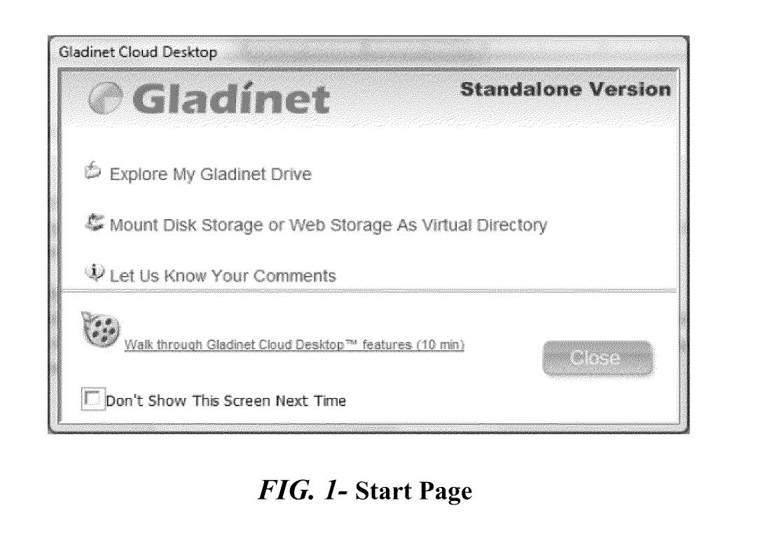

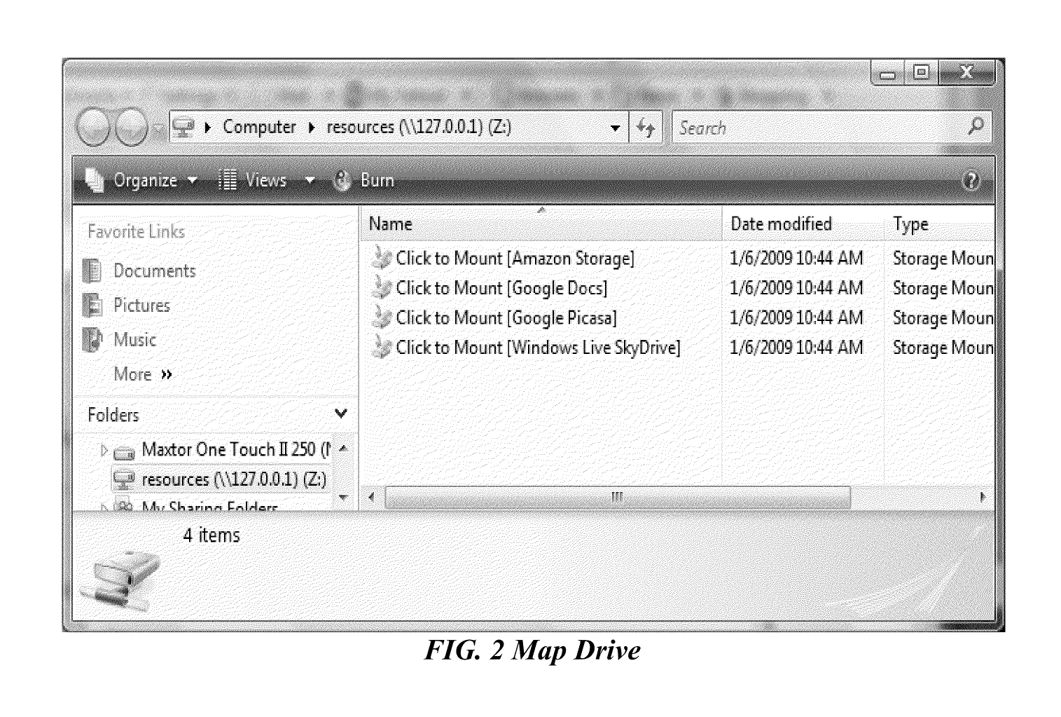

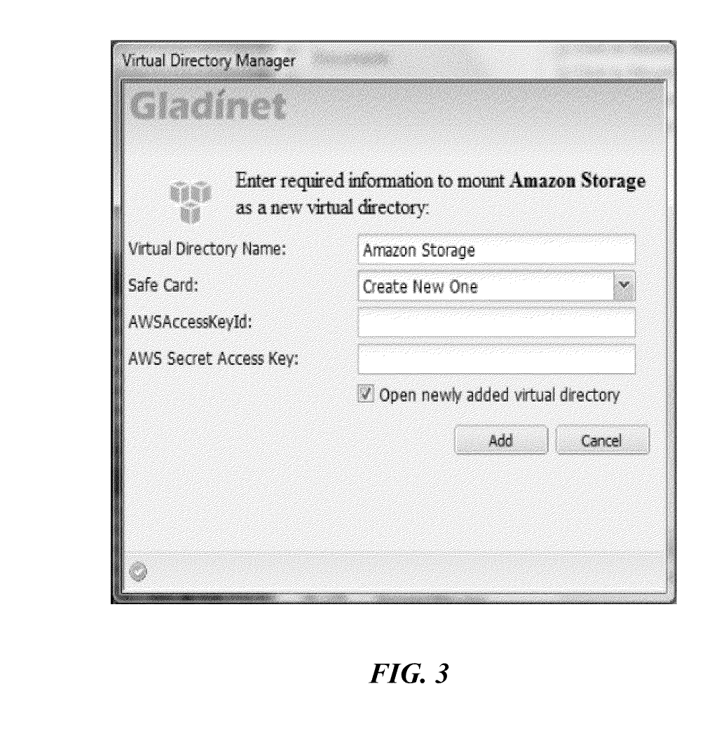

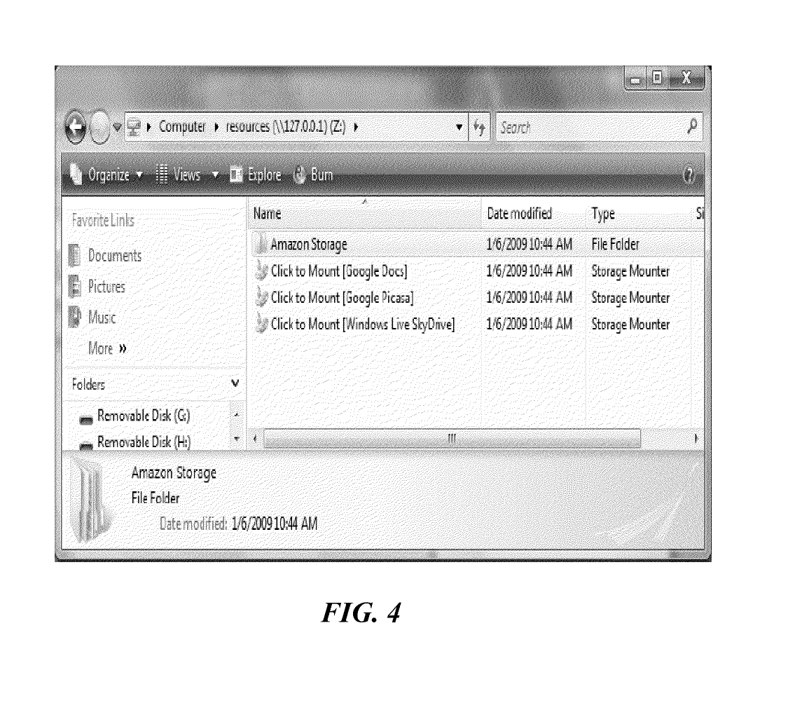

Program Start up—Upon start up you will see a simple start page (see FIG. 1). Click on the Explore My Gladinet Drive to bring you to the Mapped Drive shown in FIG. 2 (GCD will map a virtual drive into Windows). After the Gladinet Z: drive (the virtual drive) is open, the click to mount is a usability feature that allows you to click on the virtual link (Click to mount) and start mounting virtual storages. When you click on the Click to Mount [here we use Amazon Storage], you will see the box shown in FIG. 3. Here you can type in the Amazon S3 AccessKeyId and Secret Access Key to mount Amazon S3 storage. After it is mounted, you can see it from the Gladinet Virtual Drive as shown in FIG. 4.

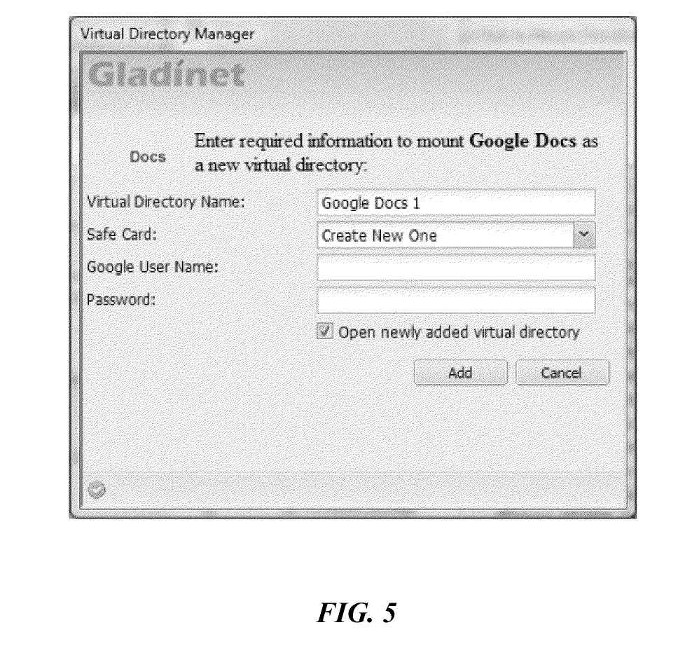

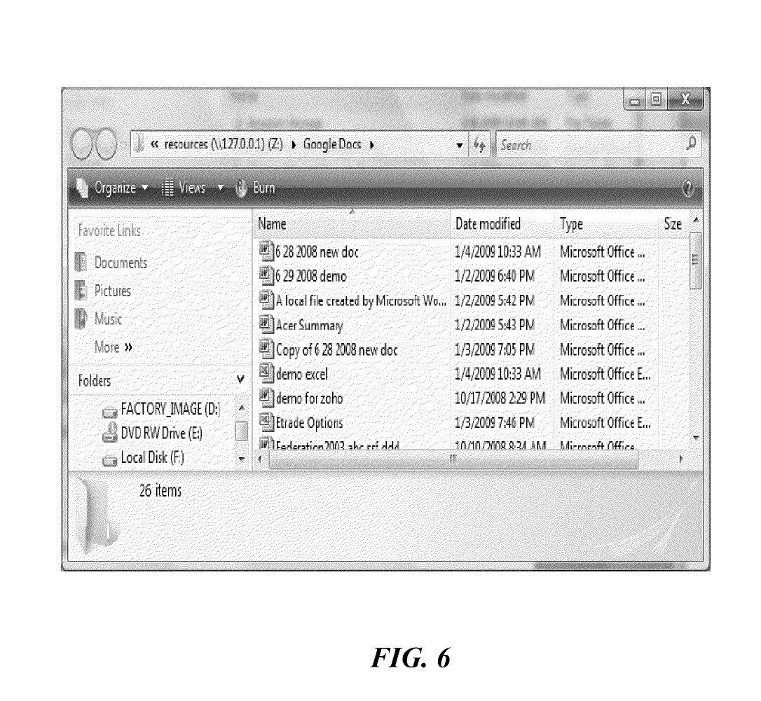

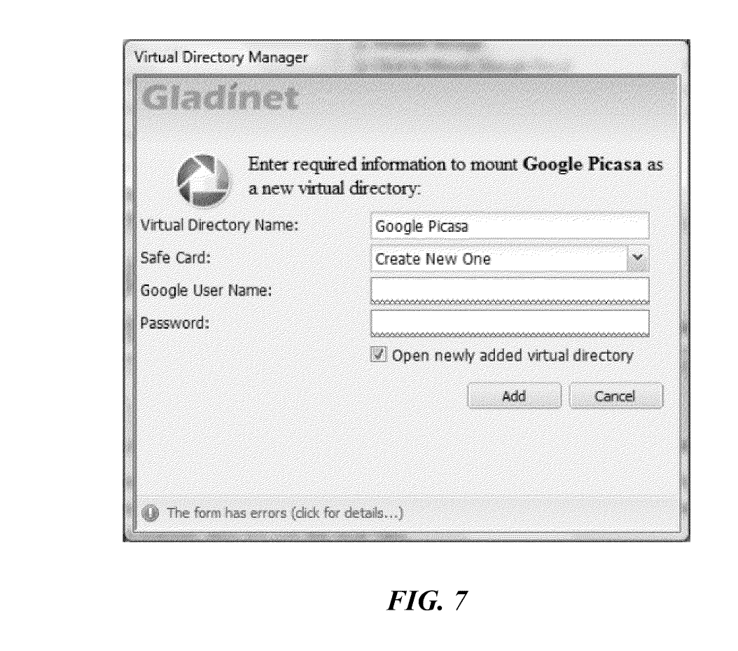

You can do the same thing for other online storages: after the Google Docs is mounted as a virtual folder in FIG. 5, you can drag and drop files into it, you can drag and drop files out of it into windows local hard drive, shown in FIG. 6. You can click on the file to modify the online file using a local word processor. They are just like local files, allowing the user to process the data on the user's own machine by downloading (caching) copies of the remotely stored data locally. Click to mount Google Picasa shown in FIG. 7.

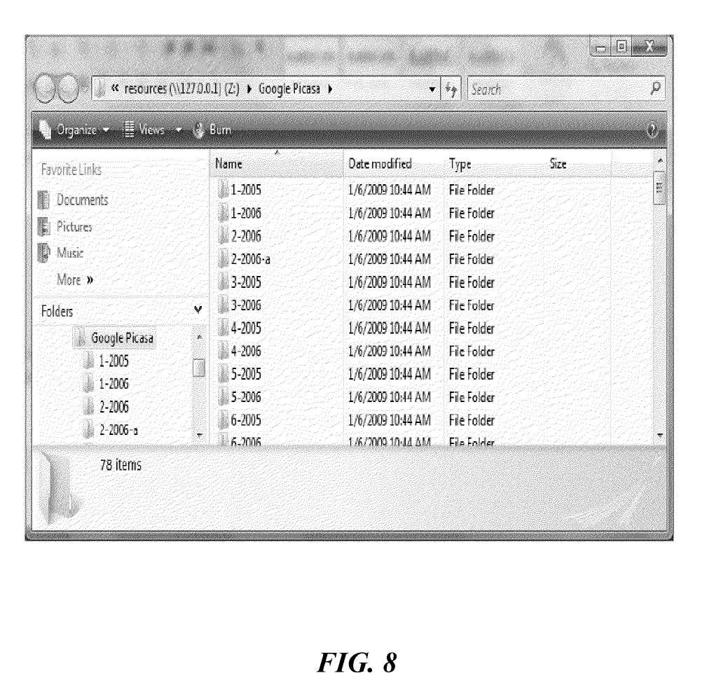

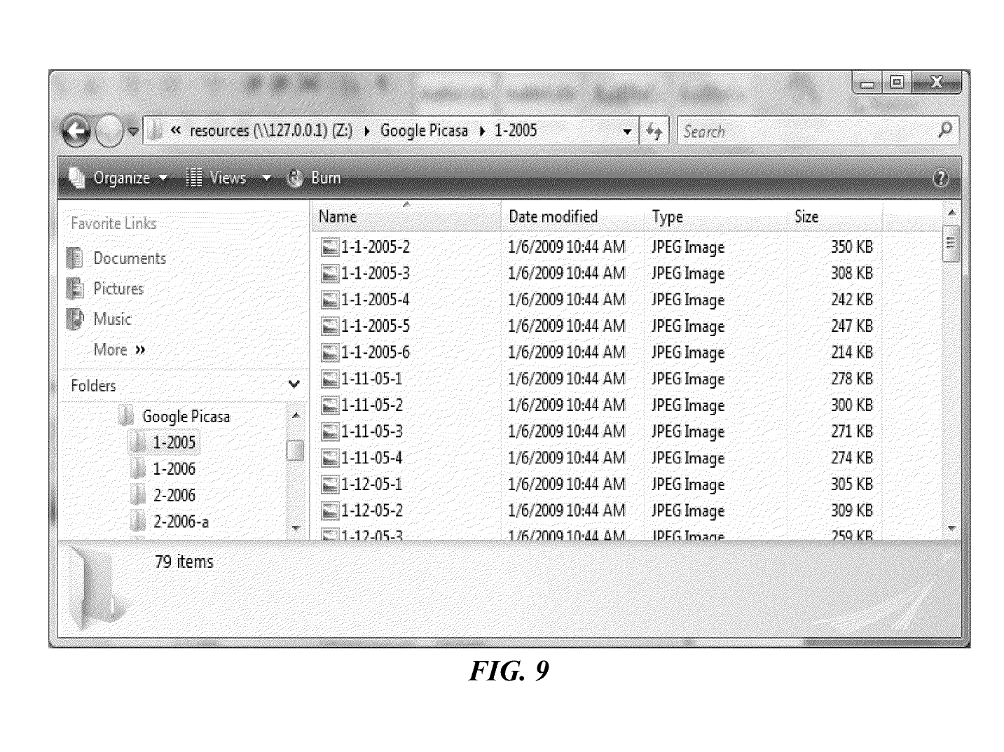

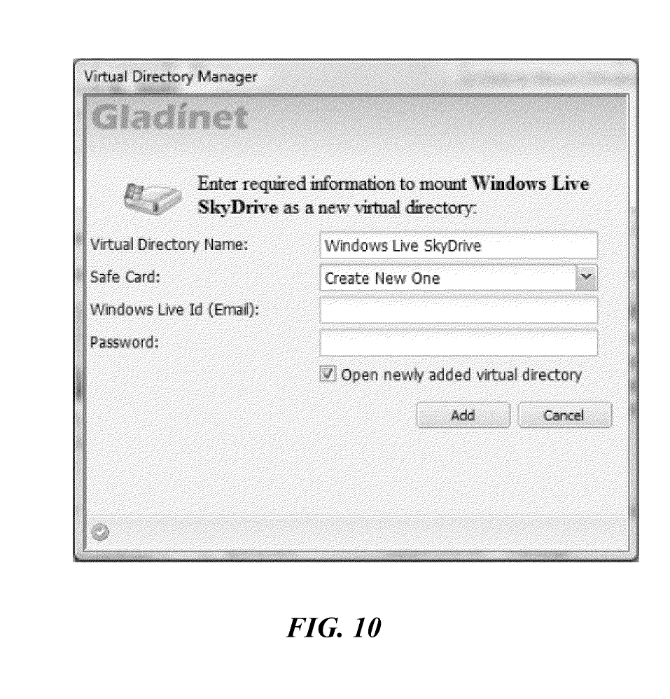

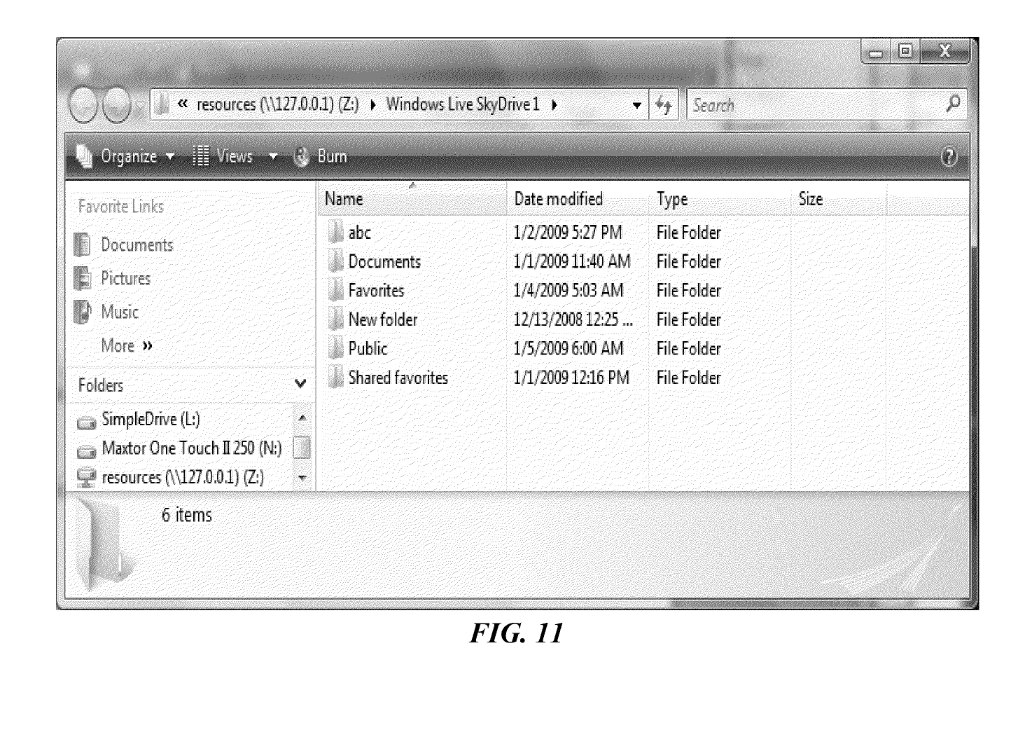

Now as shown in FIG. 8 the Web Albums appear as folders, with online Photos appearing as image files as shown in FIG. 9. If you have multiple SkyDrive accounts or multiple Google accounts, you can mount them all. See FIGS. 10 and 11.

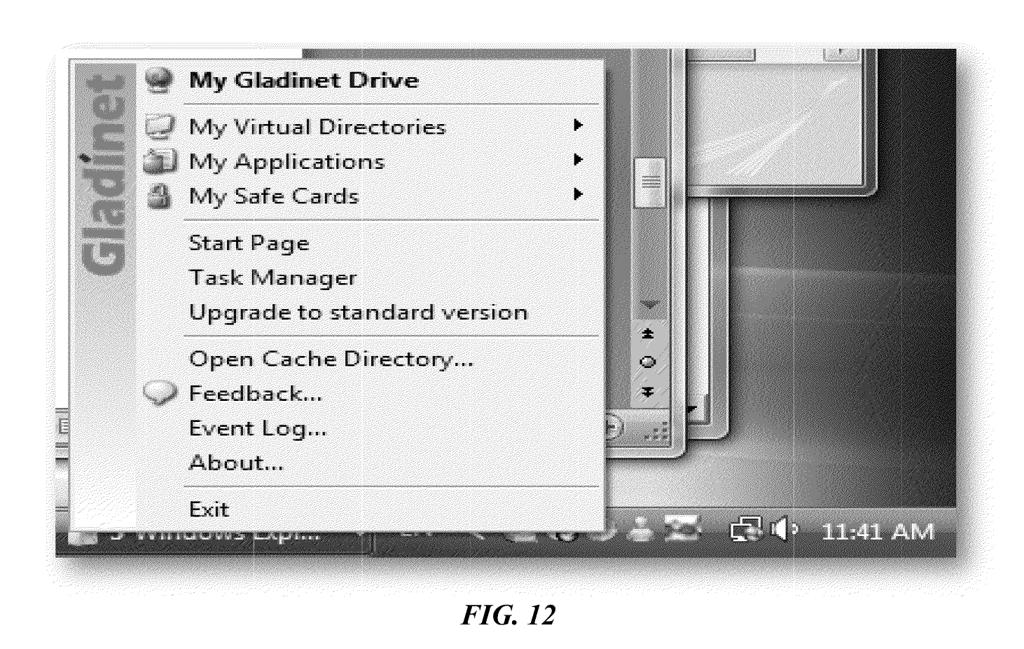

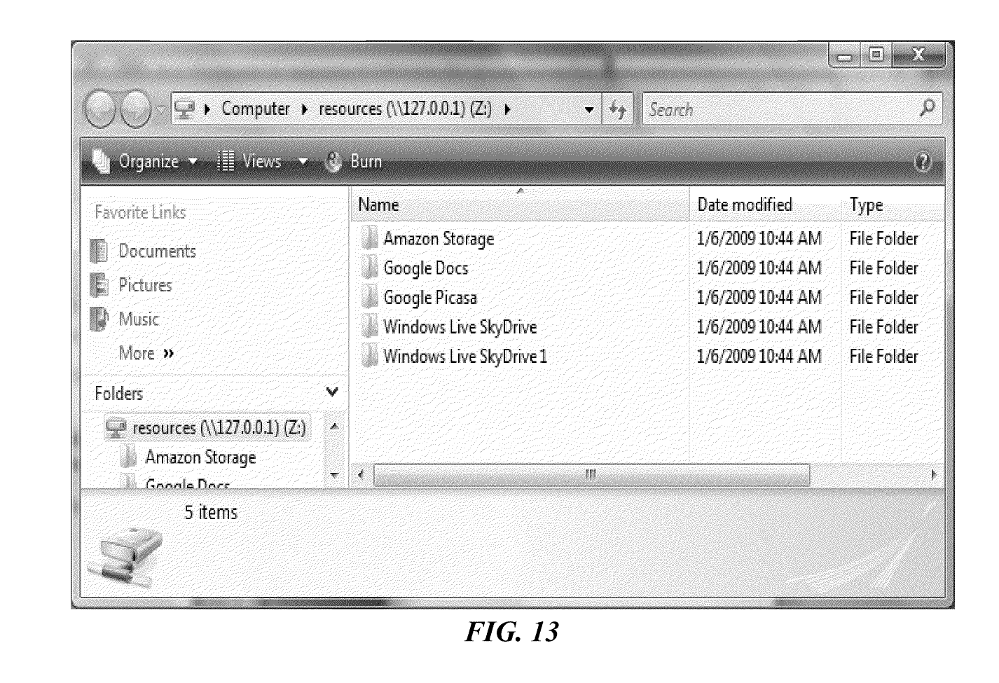

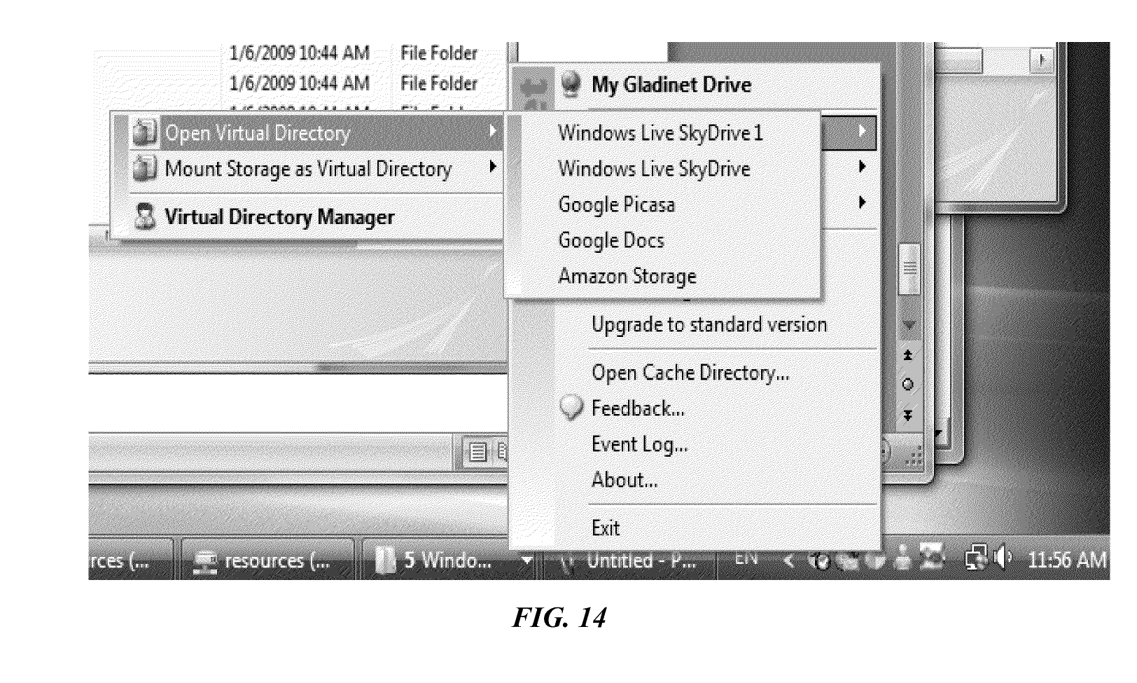

The main user interface is a system tray application shown in FIG. 12. Clicking on My Gladinet Drive will open the Gladinet Virtual Drive shown in FIG. 13. Clicking on My Virtual Directories opens Virtual Directory which will allow you to quickly get access to the mounted directories as shown in FIG. 14.

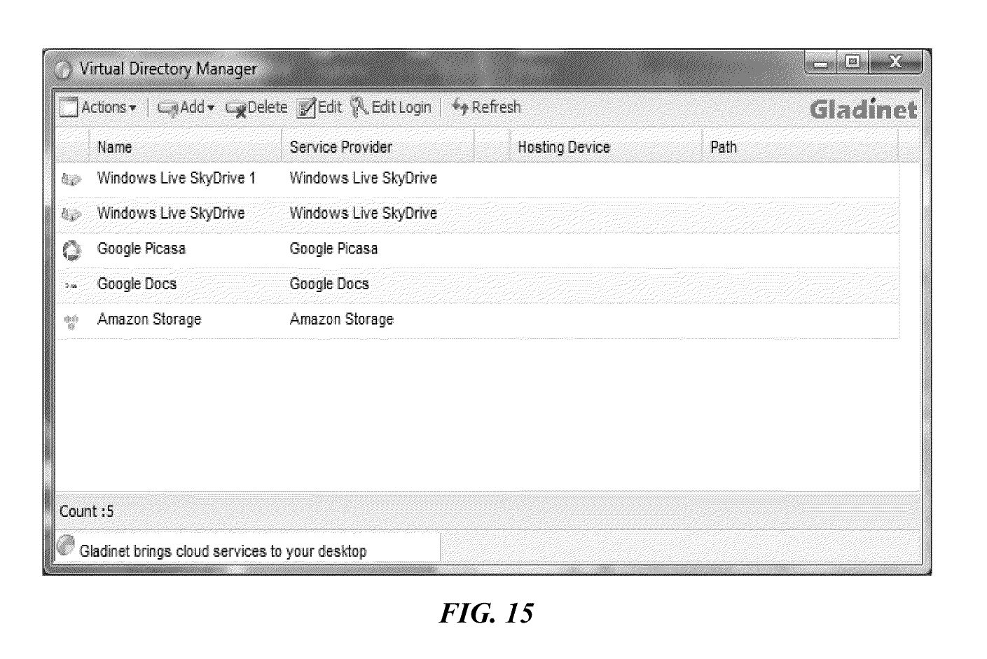

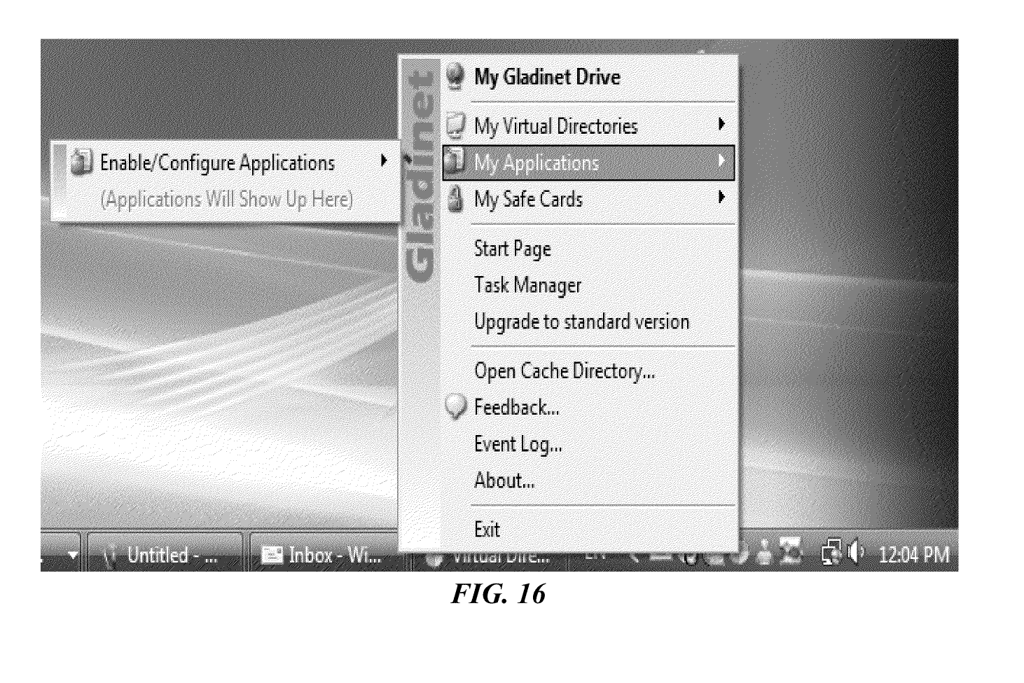

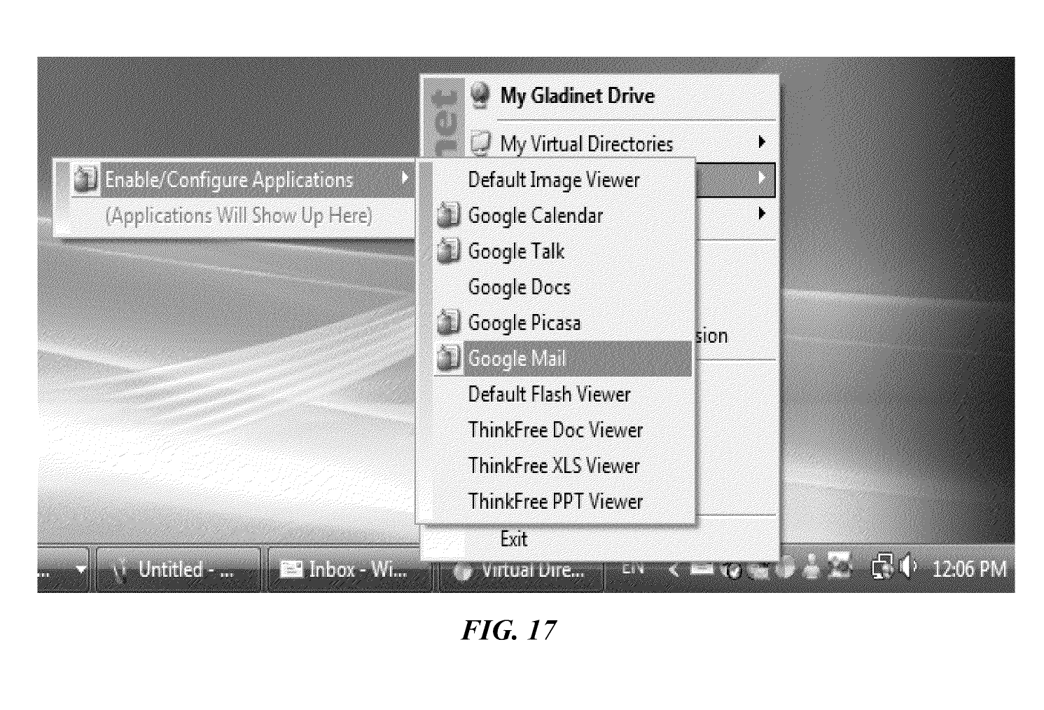

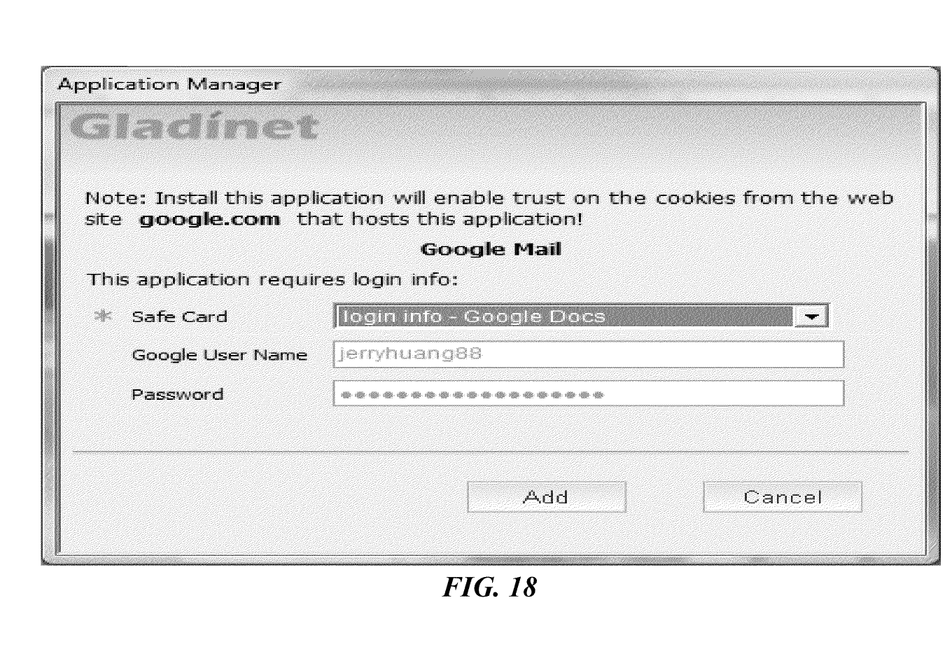

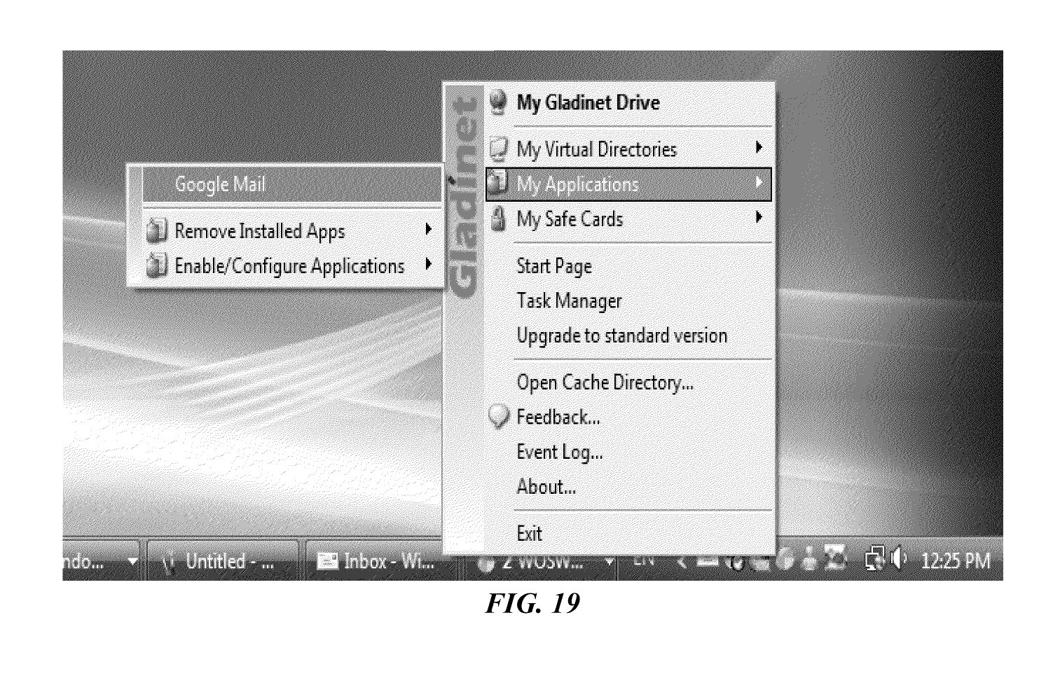

Referring to FIG. 15, there is shown a Virtual Directory Manager which is an application that allows you to mount/unmount/edit virtual directory information. Referring to FIG. 16, you can enable/configure web applications and integrate them into the Windows Explorer. Clicking on Enable/Configure Google Mail—see FIG. 17. After Gmail is configured in FIG. 18 you can open it from Systray Menu shown in FIG. 19.

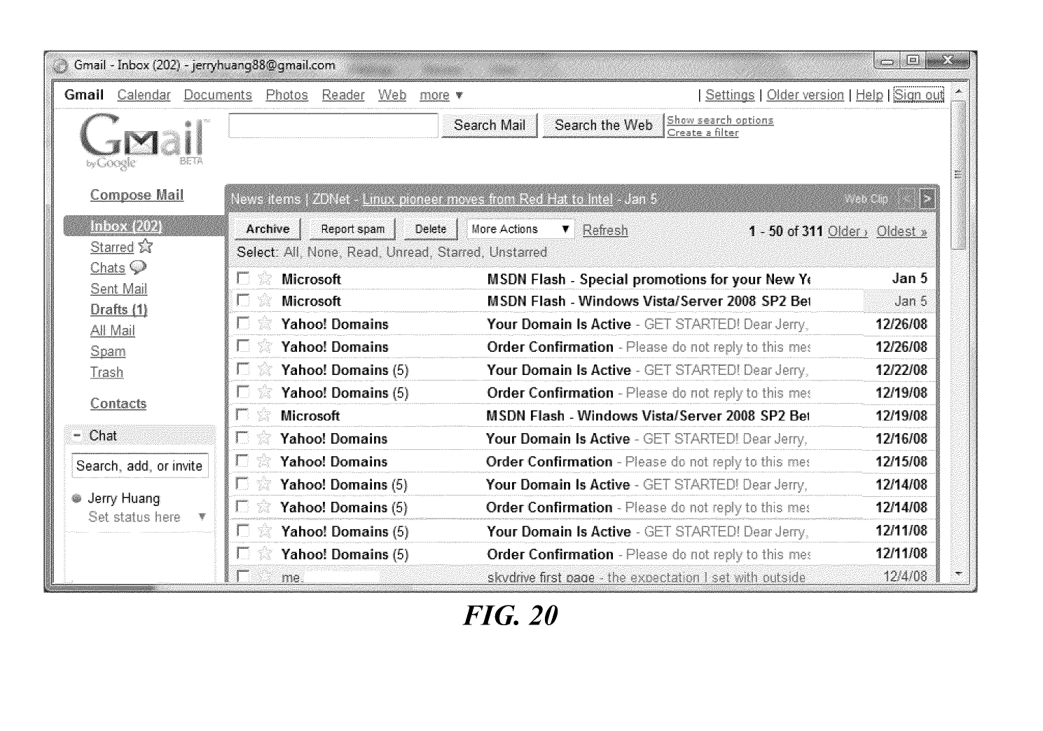

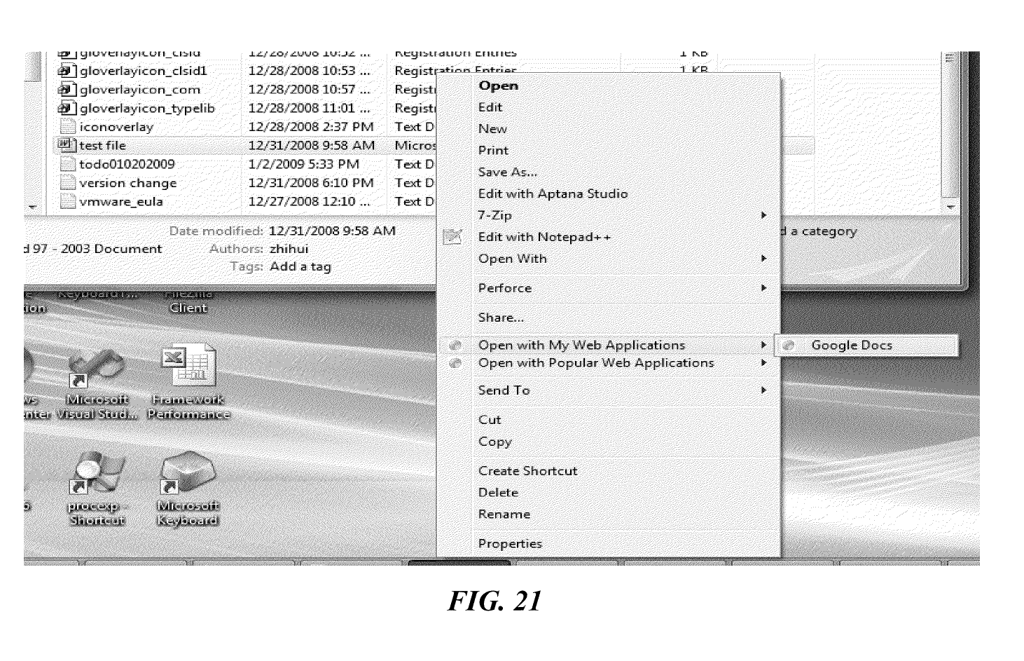

After clicking the gmail entry, the gmail will start in a standalone window application as shown in FIG. 20. You can do the same for Google Docs, after Google docs (as an online application, not just storage), you can right click a word document or excel spread sheet to edit (Use online application to edit local file). See FIG. 21.

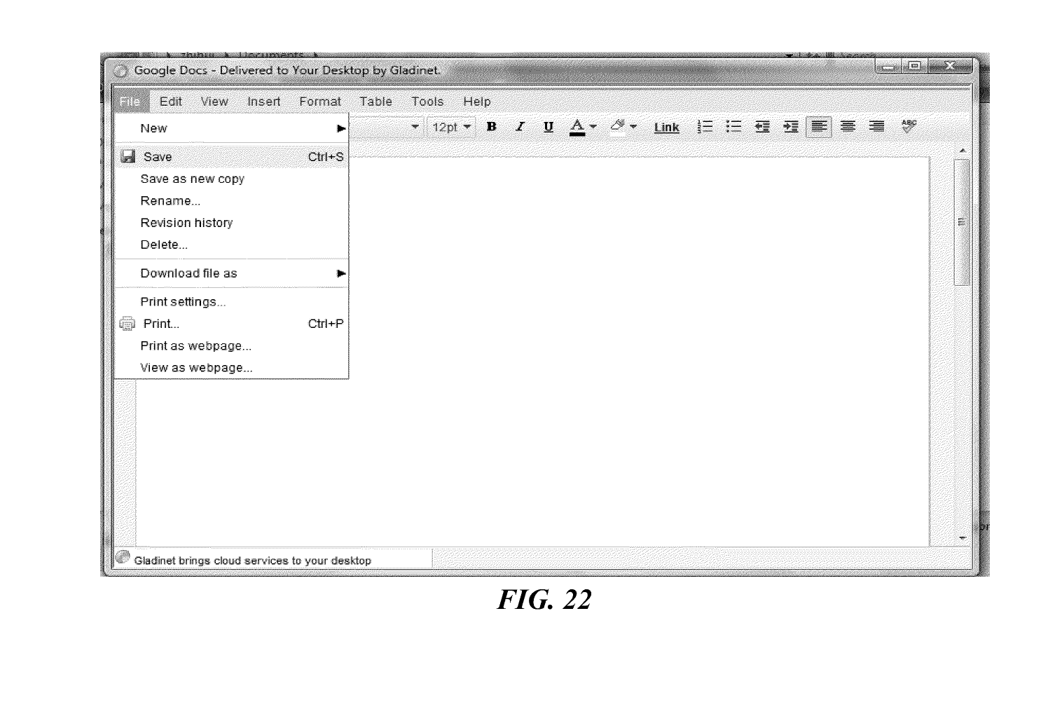

An important feature is that inside the online application Google Docs, when you do save, it can save back to the local file on your hard drive. See FIG. 22. It also works for ZOHO Writer, ZOHO Sheet; you can right click a local document and modify using online document. After you are done, you can save the document back to your local hard drive.

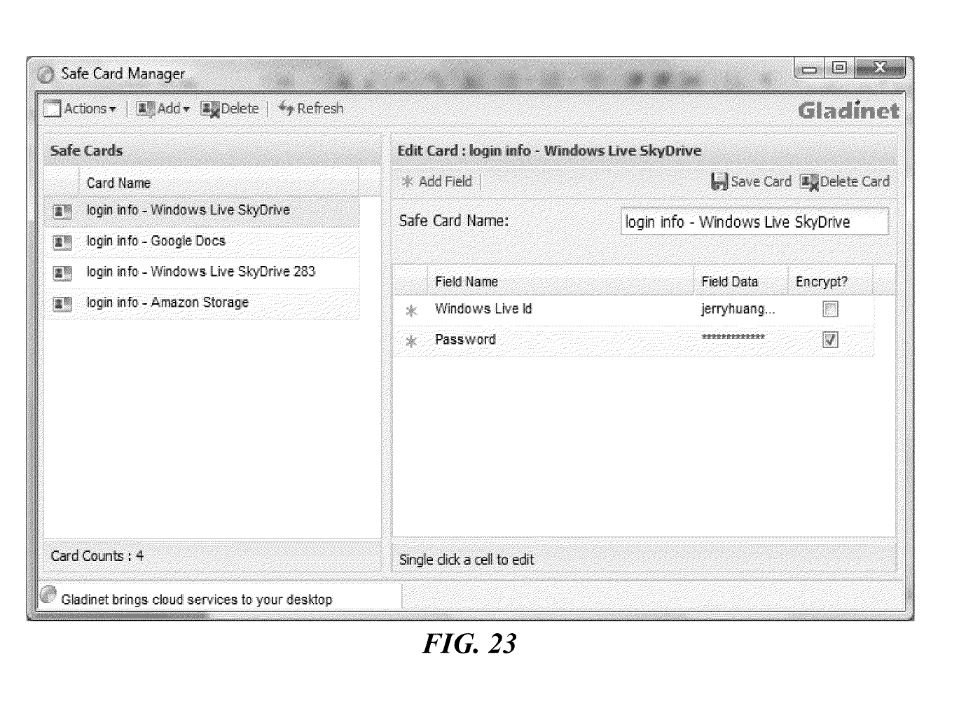

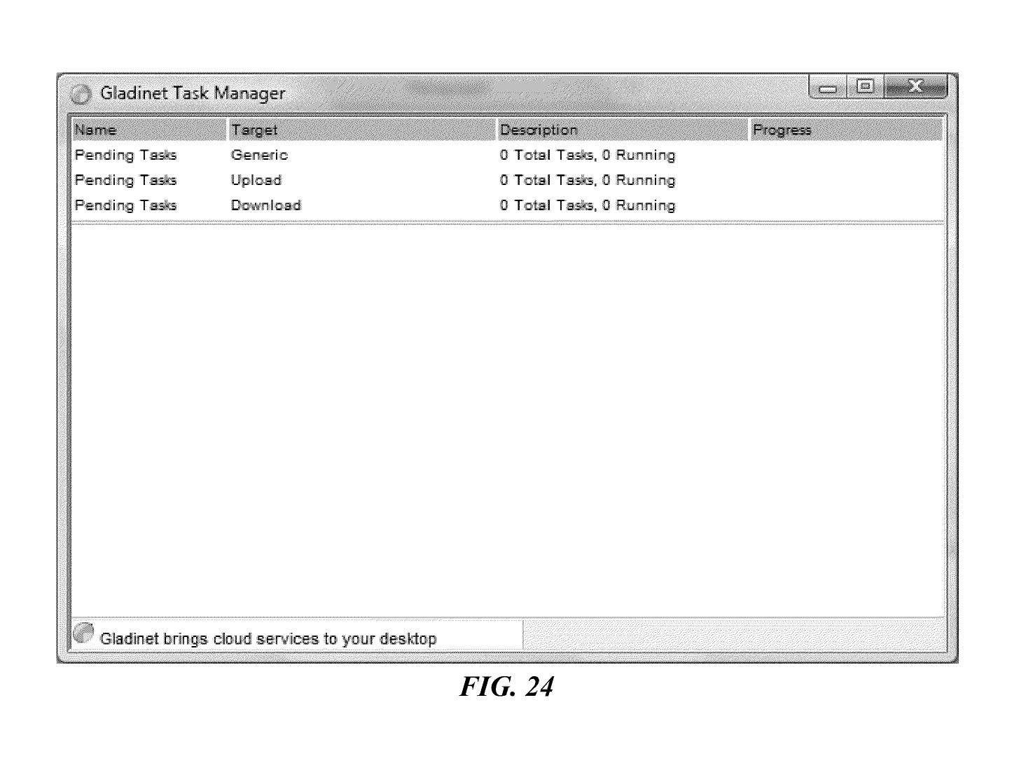

A Safecard Manager is a password manager to manage different passwords for your online application. See FIG. 23. Referring to FIG. 24, a Task Manager is an application to monitor the upload/download tasks going on in the background.

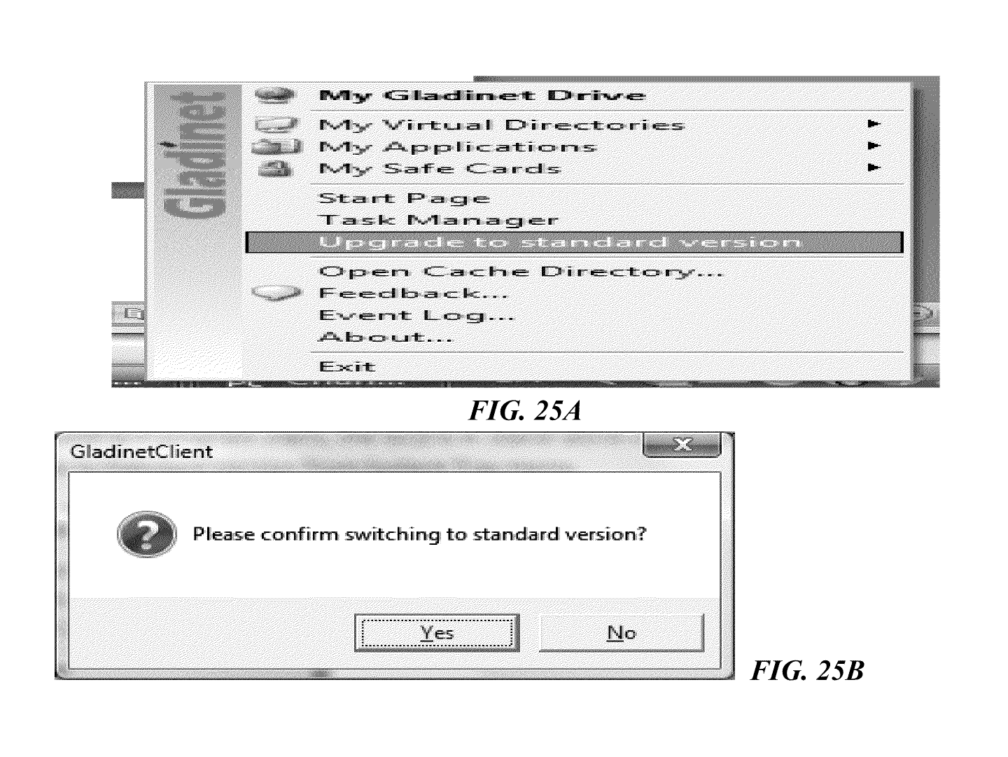

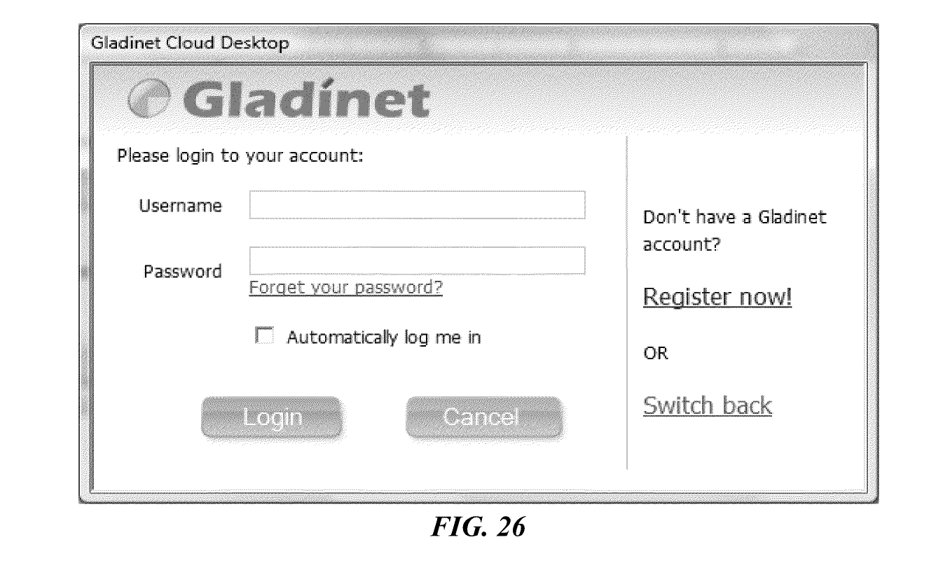

By default, upon install and program starts, the GCD is in stand-alone operation mode. However, a user can pick to upgrade to Standard Version from System Tray menu as shown in FIG. 25A and FIG. 25B. Upon starting the Standard version, you see a login screen (FIG. 26) because it requires a Gladinet Account to operate. You can either register for a new account or you can switch back to the stand-alone mode which doesn't need an account. The standard version has more features; the system tray menu is longer too.

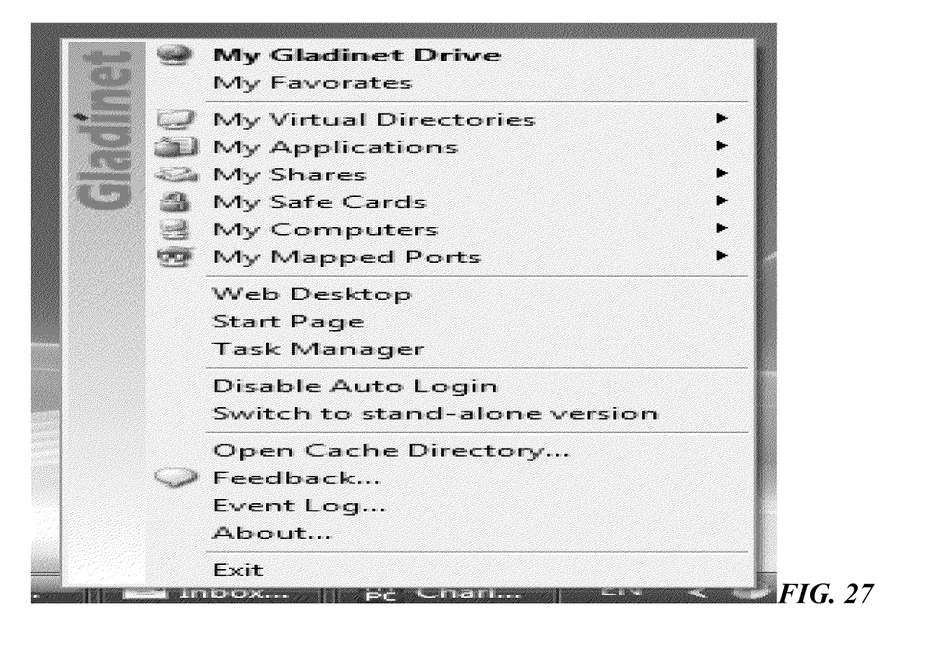

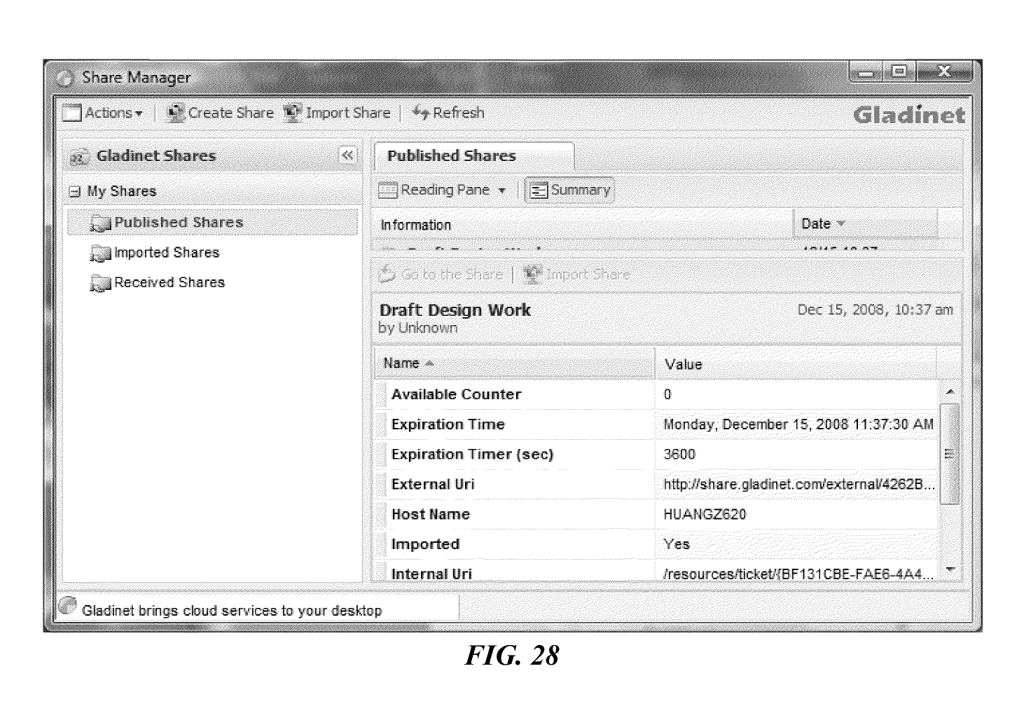

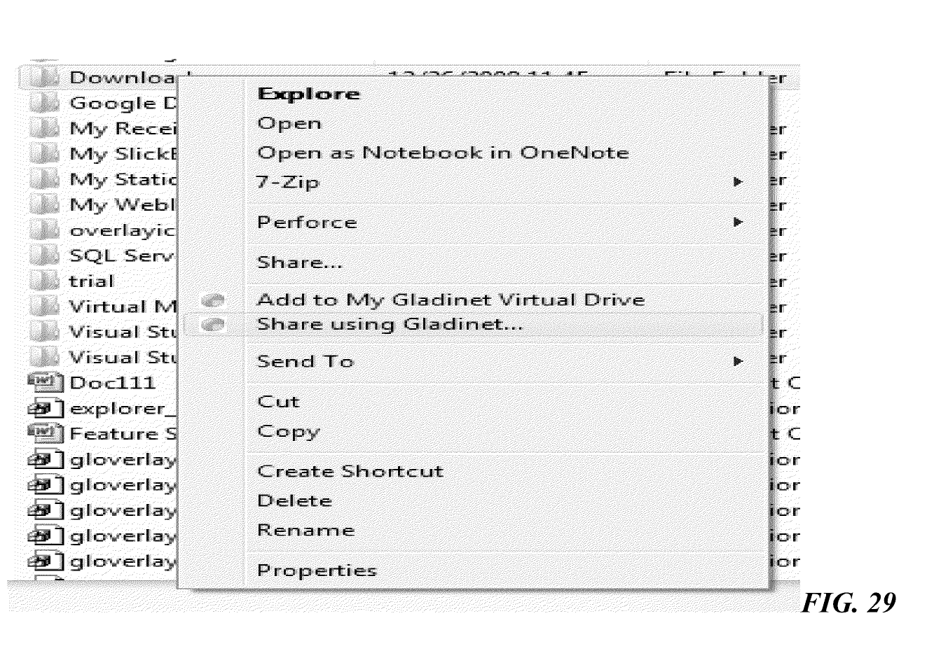

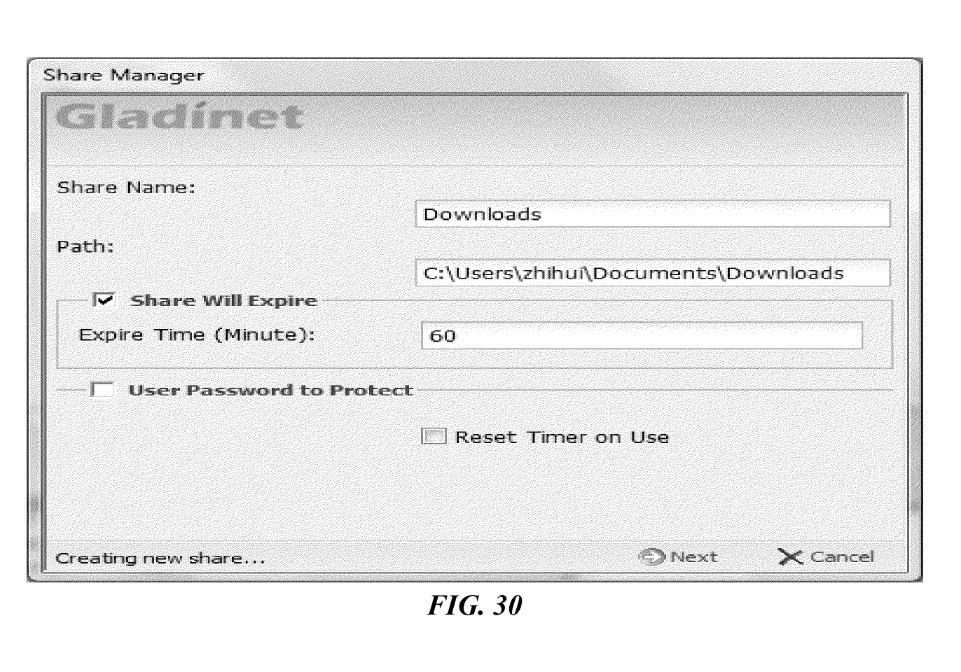

My Favorites are shown in FIG. 27. The “My favorites” feature is an aggregation of all the bookmarks from all the PCs that runs GCD with the same Gladinet account. One of the important features in the system of the invention is the ability to share local files/folders with friends. This is shown in FIG. 28—Share Manager. You can publish a local file/folder as a share, you can import a share sent to you, you can also review received shares. You can also right click a folder/file in Windows Explorer and do share in FIG. 29. After you receive a share, you can import the share into the Gladinet Virtual Drive shown in FIG. 30.

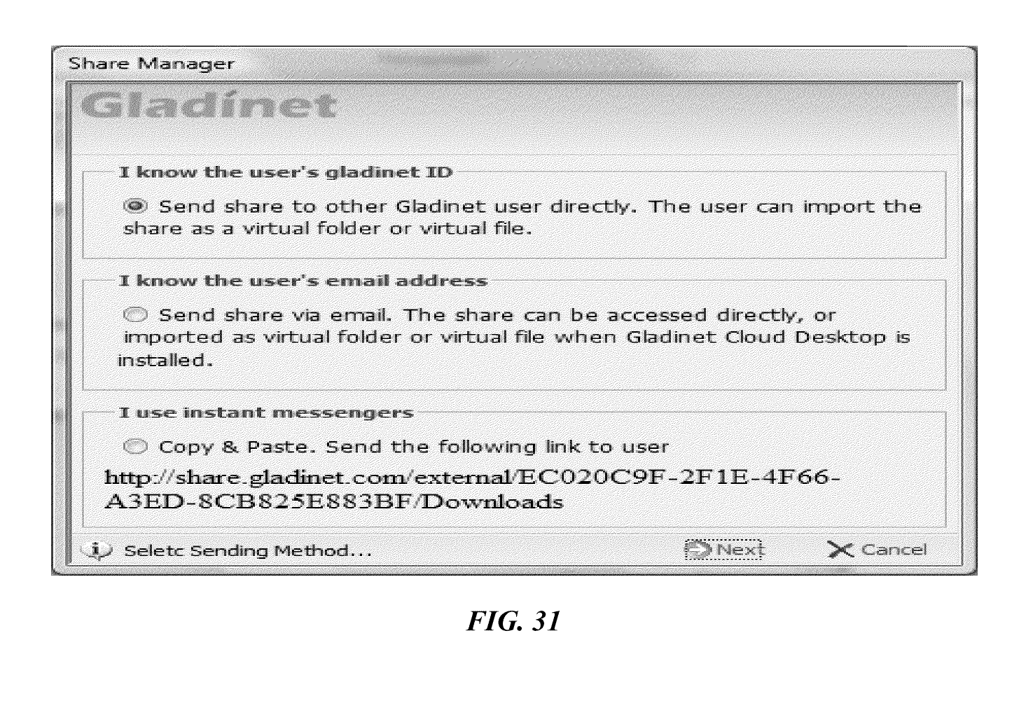

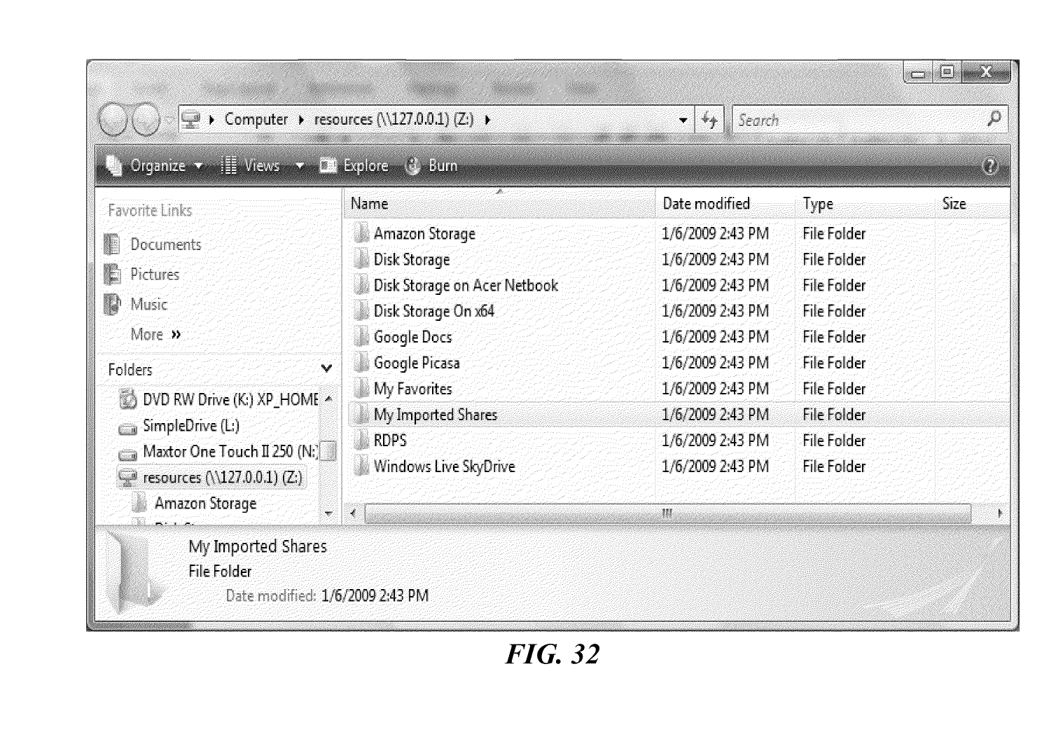

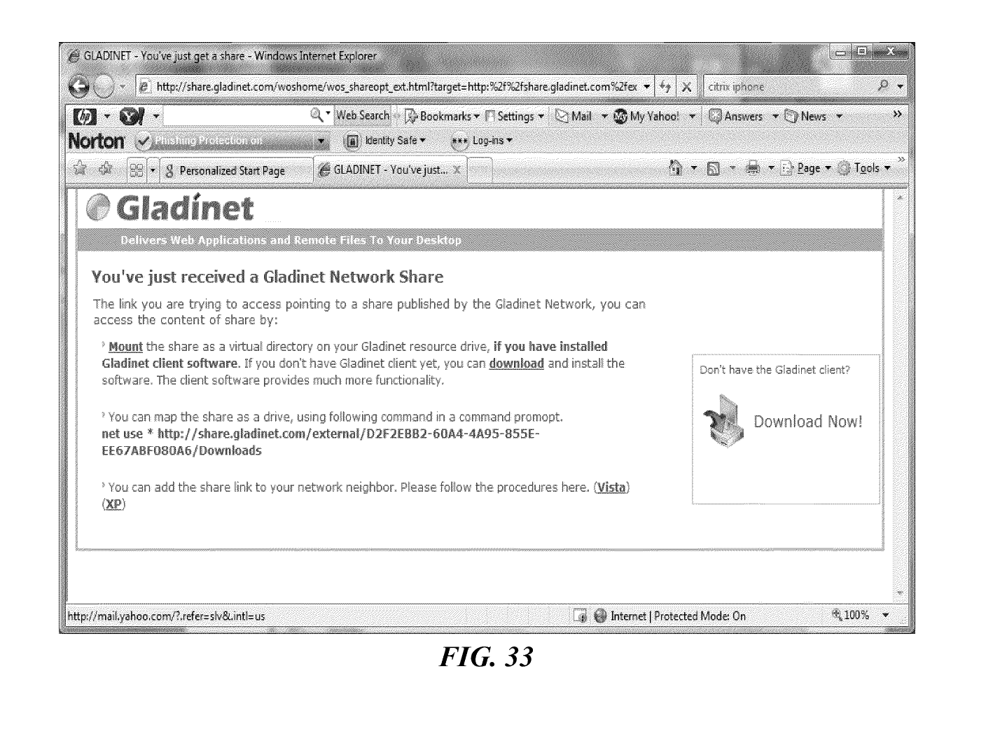

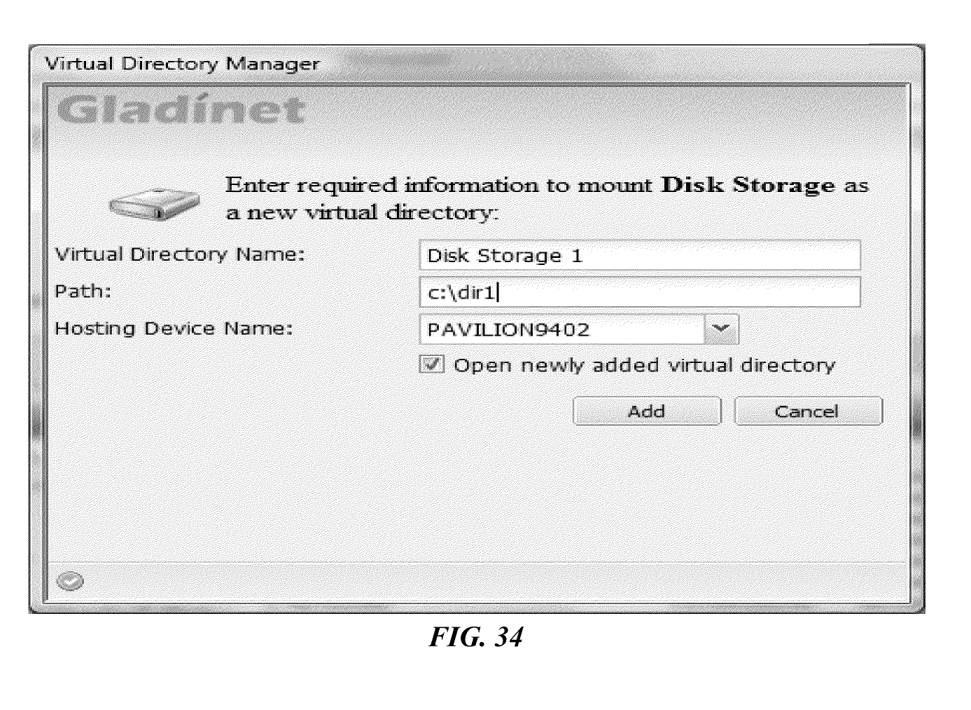

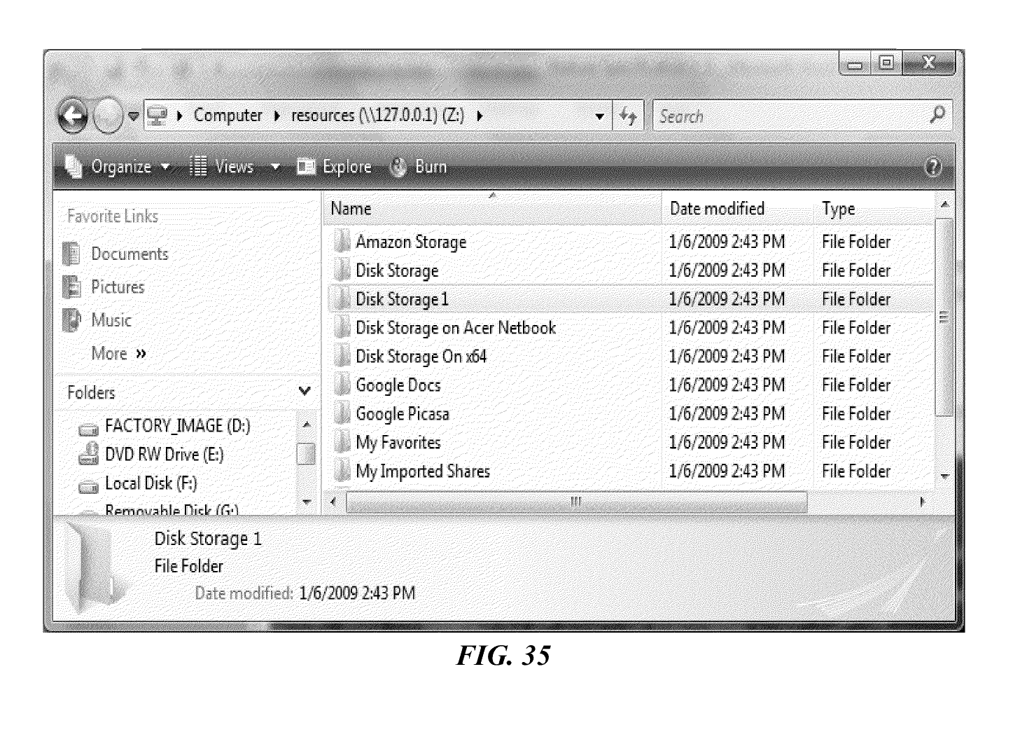

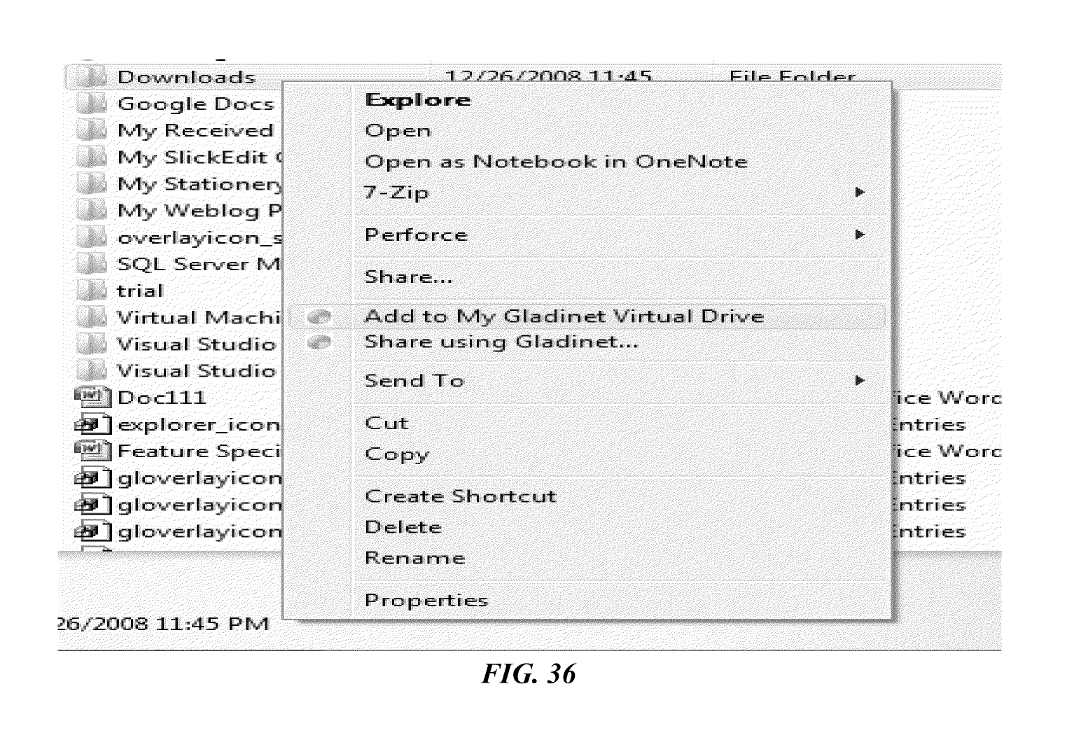

If you are not a Gladinet user and you receive a share from a Gladinet user, you will receive a link such as the one shown in FIG. 31. In FIG. 32 you can select “My Imported Shares” and in FIG. 33 you can download the share. It is very easy to mount the share as a new virtual directory as shown in FIG. 34 by selecting a directory from FIG. 35 and adding to the Gladinet Virtual Drive in FIG. 36.

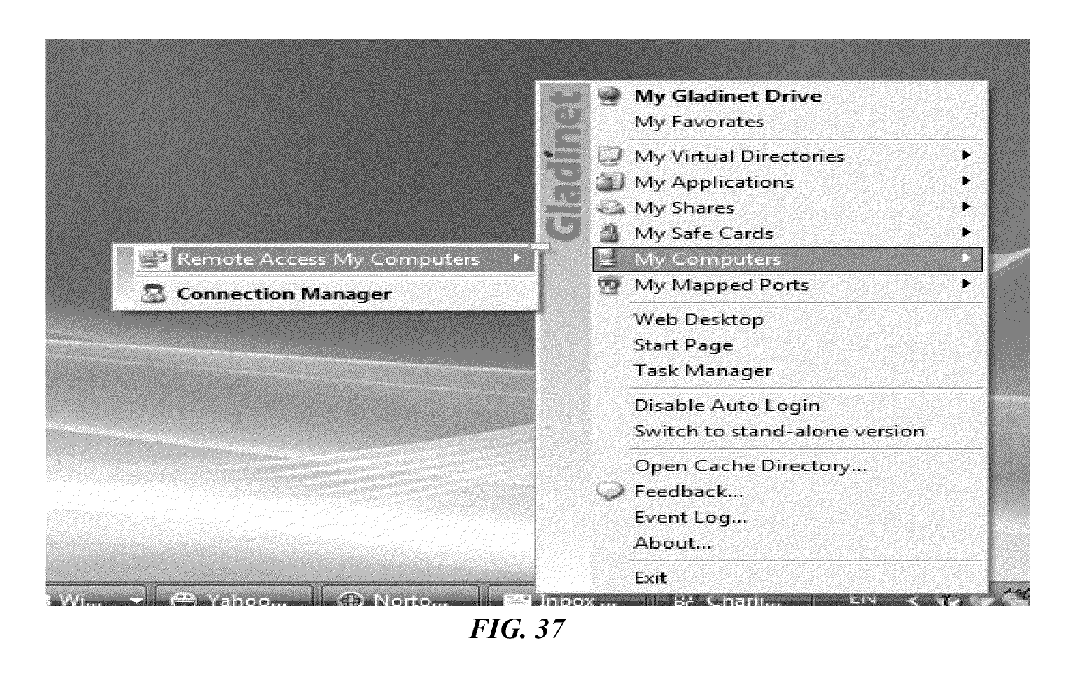

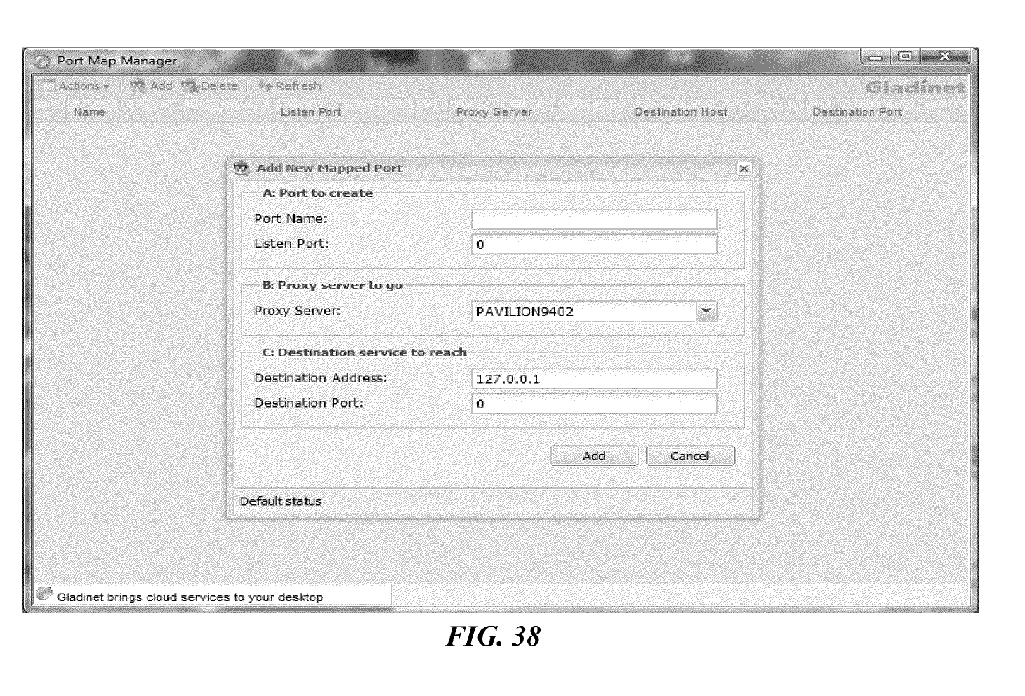

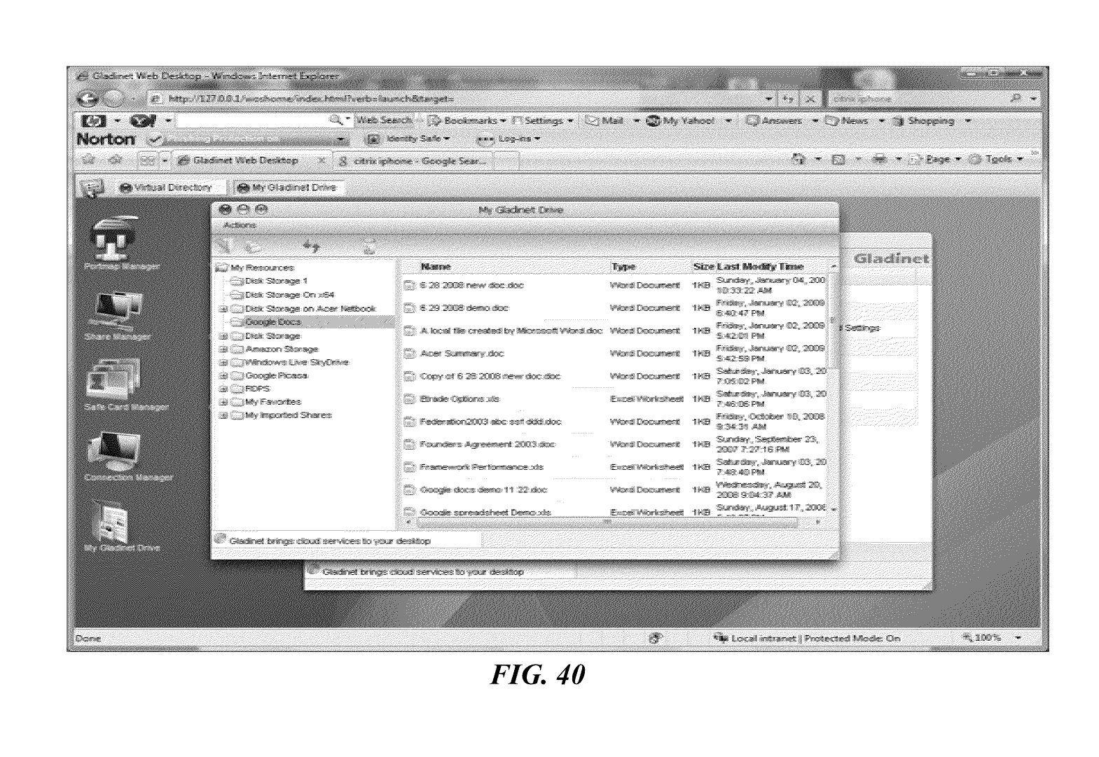

Remote access to your computer begins as shown in FIG. 37. Next in FIG. 38 the user has the ability to map a port. FIG. 39 through 41 are all webtop screens. FIG. 39 shows the Virtual Directory Manager and FIG. 40 shows the contents of the user's Gladinet Drive.

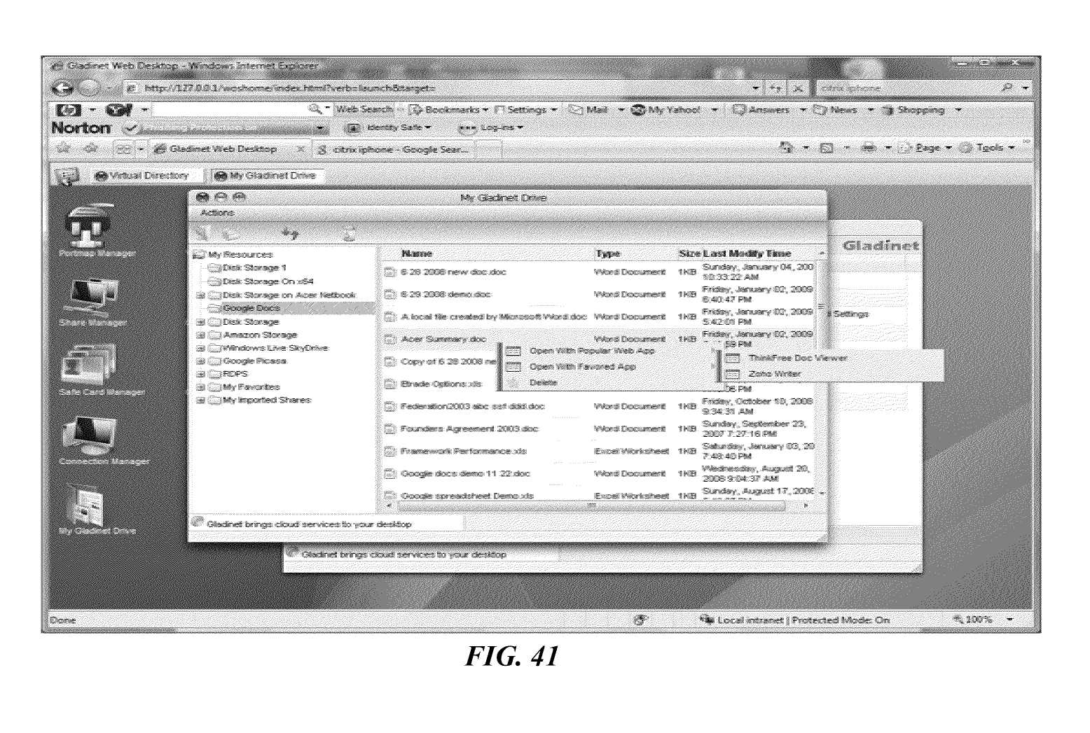

FIG. 41 shows a Gladinet Web Desktop screen. This is one example of an actual presentation of the virtual computer made up of all of the user's resources from different sources (such as from Outlook contacts, Gmail, and so on).

Referring to FIG. 42, there is shown a high level block diagram of a system according to an embodiment of the invention. The Name space root 4200 is part of the user's profile. The Name space root 4200 provides a unified view of all resources belonging to a user. The Name space root 4200 also provides a generic way to locate and access various storage items or settings items (application settings) for a user and is actually a merge view of multiple physical or virtual name space from various providers.

The namespace node 4200 as defined in the user profile is either a dummy node to create the hierarchy or it is a mounting point that defines a start point of name space from other providers. A link node 4202 contains settings that defines what plug-in 4204 (C) will be used to access the underlying name space 4200, and other items. The same plug-in 4204 can be used in multiple link nodes with different parameters.

The plug-in 4204 can also be implemented on top of other plug-ins to provide advanced functionality, such as tiered or RAID storage 4222 across multiple providers. The user also has a virtual directory called my tiered storage 4243 which is a tiered storage from remote storages 4244 and 4242. The virtual directory is the appearance of a drive on your desktop, but the drive is not actually physically located within your computer.

Finally a user can obtain the functionality/settings of application services from remote sites across the internet by a Virtual Directory called My Applications 4246. In FIG. 42, the starting point is the name space root 4200. A mounting point 4202 that marks the start point of sub-name space from a storage provider, the node contains the settings/parameters regarding how to access the name space/service provided by the provider.

The plug-in 4204 is the thin layer that virtualizes underlying storage as a generic storage object (node) in the system. A Dummy node 4208, is a place-holder, a helper object that organizes the mounting point in the system. A mounting point 4222 that has a nested plug-in 4226 mounted, this plug-in provides a RAID plug-in 4224 that can be configured to use multiple plug-ins, to create RAID service using storage service from multiple providers. These providers may belong to different business organization.

A tiered plug-in 4234 that provides tiered storage service, in the chart, the tiered storage node manages a RAID plug-in node 4226, and simple plug-in node, the tiered storage plug-in will choose the right plug-in node based on predefined criteria. It is a mounting point that has a system plug-in mounted. This plug-in exposes all application owned by the user. A Generic Application Object 4246 contains information on how to access the underlying application.

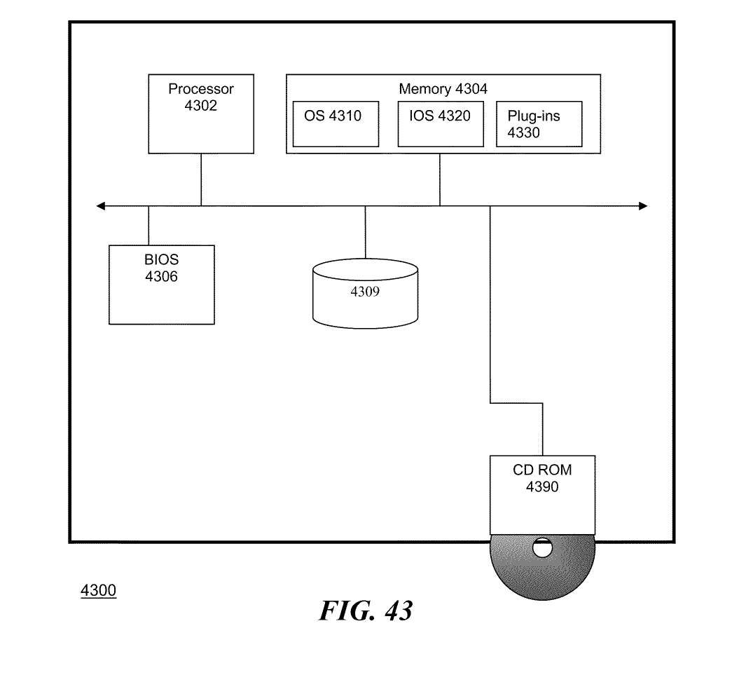

Referring to FIG. 43, there is shown a simplified diagram of an information handling system 4300 consistent with an embodiment of the present invention. For purposes of this invention, information handling system 4300 may represent any type of computer, information processing system or other programmable electronic device, including a client computer, a server computer, a portable computer such as a laptop, an embedded controller, a personal digital assistant, and so on. The computer system 4300 may be a stand-alone device or networked into a larger system.

The system 4300 could include a number of operators and peripheral devices including inter alia one or more processor devices 4302, a memory 4304, and an input/output (I/O) subsystem 4306. The processors 4302 may be general or special purpose microprocessors operating under control of computer program instructions executed from a memory.

The processor devices 4302 may include a number of special purpose sub-processors, each sub-processor for executing particular portions of the computer program instructions. Each sub-processor device may be a separate circuit able to operate substantially in parallel with the other sub-processors. Some or all of the sub-processors may be implemented as computer program processes (software) tangibly stored in a memory that performs their respective functions when executed. These may share an instruction processor, such as a general purpose integrated circuit microprocessor, or each sub-processor may have its own processor for executing instructions. Alternatively, some or all of the sub-processors may be implemented in an ASIC. RAM may be embodied in one or more memory chips. The memory may be partitioned or otherwise mapped to reflect the boundaries of the various memory subcomponents.

The memory 4304 represents either a random-access memory or mass storage. It can be volatile or non-volatile. The system 4300 can also comprise a magnetic media mass storage device such as a hard disk drive 4309. The memory 4304 comprises an operating system (OS) 4310, an Internet Operating System (IOS) 4320 and plug-ins 4330, each providing an interface between the web browser and the remote application. The plug-in 4330 uses the application program interface (api) of the web application (these are public apis) to get the remote web application to act as if it were a local application. It will then allow the user to save the data generated on the remote app to the user's computer.

The I/O subsystem 4306 includes any of various end user interfaces such as a display, keyboards, mouse, pointing device, and so on. The I/O subsystem 4306 may further include a connection to a network such as a local area network (LAN) or a wide-area network (WAN) such as the Internet. A display interface is operable for forwarding graphics, text, and other data from the Internet for display to a user. It does this by placing the web app in a frame. The user is able to access the web app by clicking on the frame.

Processor 4302 and memory 4304 components are physically interconnected using bus architecture. The system 4300 also includes removable storage unit 4390 which may be a compact disc (CDROM), digital video disk (DVD), magnetic tape, optical disk, removable memory chip, and others. The removable storage unit has stored therein program instructions for enabling computer 4300 to operate according to an embodiment of the present invention.

What has been shown and discussed is a highly-simplified depiction of a programmable computer apparatus. Those skilled in the art will appreciate that a variety of alternatives are possible for the individual elements, and their arrangement, described above, while still falling within the scope of the invention. Thus, while it is important to note that the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of signal bearing media include ROMs, DVD-ROMs, and transmission-type media, such as digital and analog communication links, wired or wireless communications links using transmission forms, such as, for example, radio frequency and light wave transmissions. The signal bearing media make take the form of coded formats that are decoded for use in a particular data processing system.

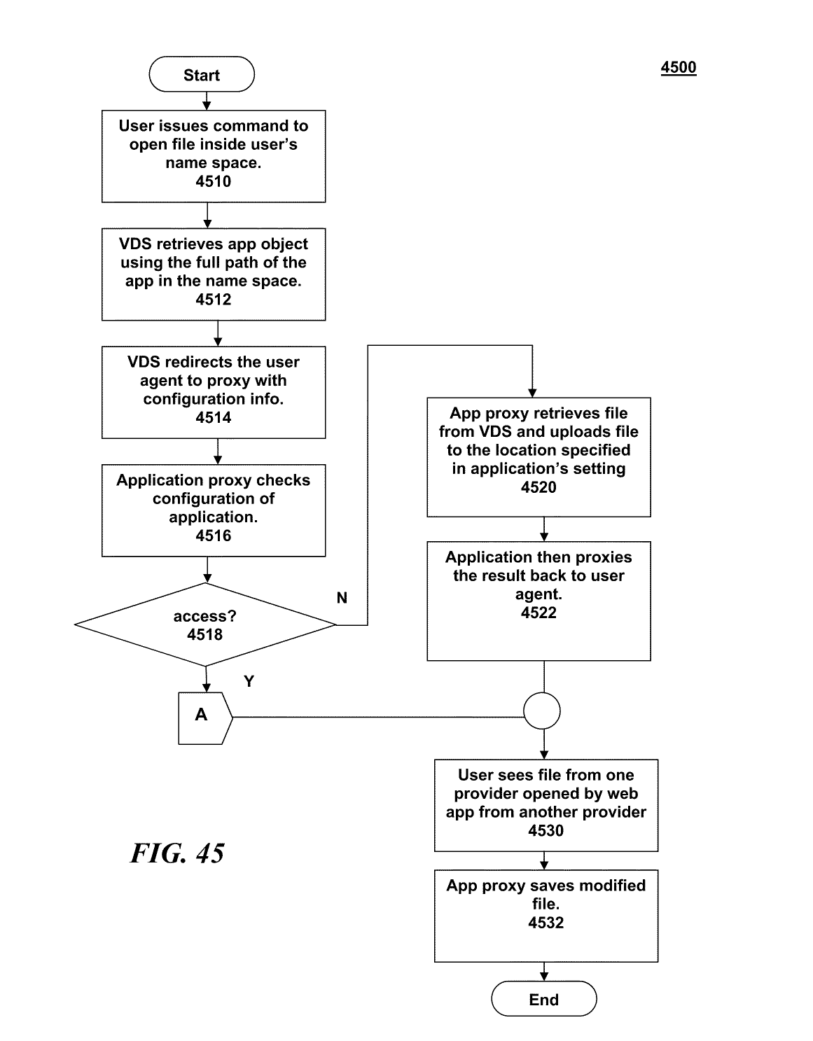

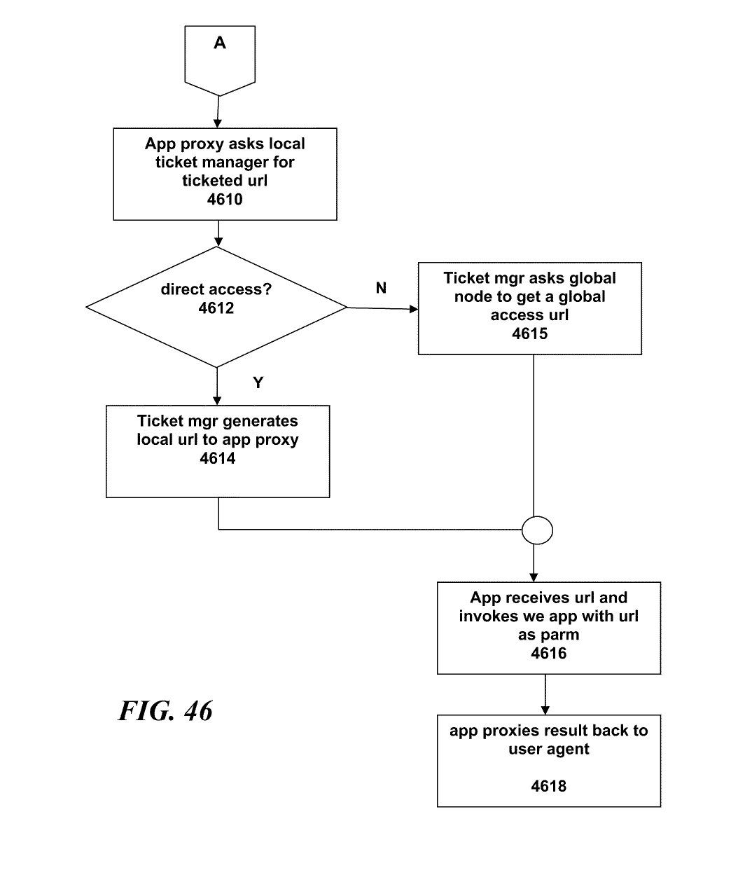

Referring now to FIG. 44, there is shown a simplified diagram of an embodiment 4400 of application virtualization. Application virtualization as described herein will allow a user 4490 to invoke a generic web application with the appropriate channel/mechanism to access another object (data) stored on the Web by another service provider. Continuing with the real-world example stated earlier, assume website 1 4401 contains a file (such as a document from Amazon S3 (Amazon Simple Storage Service) by Amazon Web Services LLC. Website 2 4402 has a web application 4413 such as Zoho Writer. Automating the interaction of the two disparate resources (the document from website 1 and the web application from website 2) involves the user 4490, through a Virtual Desktop Service (VDS) 4430 accessing the Internet Operating System (IOS) 4450 through a user interface 4406. The following descriptions of FIGS. 45 and 46 will serve to describe the method for application virtualization.

In FIG. 45 we present a simplified flow chart of the automatic method for application virtualization. First in step 4510, the user 4490 (via an agent, such as a browser or application shell) issues a command to the VDS to open a file on website 1 (4401) using a web application 4413 provided by website 2 (4402) by using a generic application to open the file inside the user's name space. For example the user will open file 1 located at file=/amazons3/dir1/dir1/demo.txt (file's virtual path to amazons3) or file=/local drive/dir1/dir2/demo1 .txt (file on local file system). The web application the user wants to use is at http://docs.google.com which supports editing a text file by URL (http://docs.google.com/edit?url=xxx).

Next in step 4512, the VDS retrieves the application object using the full path of the application in the name space. In step 4514 the VDS redirects the user agent to an application proxy with configuration information. In step 4516 the application proxy checks the configuration of the application. If at decision 4518 it is determined that the application supports accessing the desired resource defined in the url (uniform resource locator), we perform the steps shown in FIG. 46, discussed later.

If, however, at decision 4518 it is determined that the application does not support accessing the desired resource as defined in the url, we go on to step 4520 where the application proxy retrieves the file from VDS and uploads the file to the location specified in the application's profile. Then in step 4522, the application then transmits the result back to the user agent. The result is transmitted back in the form of a binary stream of the file content. It is transmitted back to the user's PC, where the IOS agent is running So the IOS agent knows where the transmit target is in the namespace, it will then send the request to the proper plug-in for the part of the name space and the plug-in will save the file.

In step 4530 the user now sees that his/her file from one provider is opened by a web application from another provider and processes the file accordingly. Lastly, in step 4532 the application proxy saves the modified file by reversing the steps it took to retrieve the file.

In FIG. 46 we discuss the method steps performed when it has been determined that the application supports accessing the desired resource defined in the URL. In step 4610, the application proxy asks the local ticket manager for a ticketed URL. In step 4612, the ticket manager determines if the instance of the requested resource can be accessed directly. If it can, then in step 4614, the ticket manager generates a local url to the application proxy (e.g., http://localhost:port/sharable_url_for_demo.txt). If not, then in step 4615, the ticket manager asks a global node to retrieve a global access url (e.g., http://share.gladinet.com/sharable_url_for_demo1_with ticket.txt). In step 4616, the application is able to retrieve the url and invokes the web application with the url as one parameter as instructed by the application setting profile. In step 4618 the application proxies the result back to the user agent. Since the web application is virtualized into a shell, an app frame hosting the web page, the hosting app, can launch the Google docs such as:

http://docs.google.com/edit?url=http://share.gladinet.com/sharable_url_f or demo1_with_ticket.txt.

Then the share.gladinet.com has a channel with the local PC that hosting the demo1.txt and the demo1 will be retrieved on demand from the local PC to the share.gladinet.com and then go to docs.google.com for editing.

Therefore, while there has been described what is presently considered to be the preferred embodiment, it will understood by those skilled in the art that other modifications can be made within the spirit of the invention. The above descriptions of embodiments are not intended to be exhaustive or limiting in scope. The embodiments, as described, were chosen in order to explain the principles of the invention, show its practical application, and enable those with ordinary skill in the art to understand how to make and use the invention. It should be understood that the invention is not limited to the embodiments described above, but rather should be interpreted within the full meaning and scope of the appended claims.

We claim:

1. A computer-implemented method for virtualization of a remotely located storage resource, said method comprising:
using a processor device for:
receiving a first request from a user, said request comprising an identification of the storage resource;
authenticating the user request;
virtualizing the storage resource by creating a node for presentation to the user, wherein said node represents the storage resource;
presenting the node to the user;
receiving a second request from the user for data stored in the storage resource represented by the node;
retrieving the requested data from the storage resource; and
presenting the requested data to the user on the node.

2. The method of claim 1 wherein the step of virtualizing the storage resource further comprises a step of creating a virtual local area network (LAN) with an underlying point to point channel to connect devices located in different LANs and behind a firewall.

3. The method of claim 2, further comprising aggregating all virtualized storage resources using a centralized user profile.

4. The method of claim 3 further comprising exposing the aggregated resources through a virtual desktop/disk which has various presentation layers.

5. The method of claim 4 wherein the aggregating comprises:
aggregating all storage resources into a virtual disk;
providing a unified name space across multiple storage providers, wherein said namespace has hierarchy support, and wherein each node of the name space comprises a storage plug-in associated with said node to provide actual storage service.

6. The method of claim 5, further comprising enabling building a redundant array of independent drives (RAID) using multiple storage providers, with multiple cloud storage provided by different providers.

7. The method of claim 6, further comprising mounting a RAID plug-in as the node of the name space described.

8. The method of claim 6, further comprising the RAID storage plug-in configured to support different redundant configuration or algorithm.

9. The method of claim 6, further comprising providing tiered storage across multiple storage providers.

10. The method of claim 6, further comprising:
providing a tiered storage plug-in built upon other plug-ins; and
providing a nested plug-in.

11. The method of claim 6, further comprising mounting a tiered storage plug-in as a node of the namespace.

12. The method of claim 6, further comprising providing a tiered storage plug-in configured for to determine which underlying storage plug-in serves the request.

13. The method of claim 2 further comprising invoking a generic web application through the point to point channel to access other objects stored in other service providers.

14. The method of claim 3 further comprising exposing the aggregated resources through the virtual desktop/disk which has various presentation layers.

15. A computer-implemented method for application virtualization comprising:
using a processor device for:
receiving a command from a user to open a file on a first website using an application from a second website that is different from the first website, said command comprising a location of the first website and a location of the second website;
creating a global namespace for the user;
defining a generic application interface for the application, said interface comprising following application settings:
the location of the second website;
a type of the application; and
supported commands for the application;
virtualizing the application settings as a generic application object represented as an application node in the global namespace;
retrieving the generic application object using a full path of the application in the global namespace;
checking a configuration of the application by verifying the application settings;
determining whether the application supports accessing the first website as defined by its uniform resource locator;
using the uniform resource locator of the first website, invoking the web application using said uniform resource locator as one parameter as instructed by the application setting, wherein invoking the web application causes said application to execute using the file as input; and
transmitting results of the execution of the file to the user.

16. The method of claim 15, wherein determining whether the application supports accessing the first website comprises:
if the application does not support accessing the desired resource as defined in the url, the application proxy retrieves the file from the VDS and uploads the file to the location specified in the application's profile; and
if the application supports accessing resource defined in a uniform resource locator (URI), the application proxy asks a local ticket manager for a ticketed URI; a ticket manager detects this instance can be accessed directly, it will generate a local URI to application proxy;
the ticket manager detects this instance cannot be accessed directly, it will ask global node to get a global access URI.

17. The method of claim 16 further comprising, after performing the step of virtualizing the application settings:
virtualizing a storage resource defined by the first website by creating a storage node for presentation to the user, wherein said storage node represents the storage resource.

18. The method of claim 17 further comprising a step of creating a virtual local area network (LAN) with an underlying point to point channel to connect devices located in different LANs and behind a firewall.

19. The method of claim 18, further comprising aggregating all virtualized storage resources using the global namespace.

20. The method of claim 19 further comprising exposing the aggregated resources to the user through a virtual desktop/disk which has various presentation layers in order to enable interaction between the virtualized application and the virtualized storage resource.

21. A system for virtualizing a web application and a remotely located storage resource, said system comprising:
a processor device for:
creating a global namespace;
virtualizing the storage resource by creating a storage node for presentation to the user, wherein said storage node represents the storage resource;
defining a generic application interface for the web application; and
virtualizing the application settings as a generic application object represented as an application node in the global namespace;
a memory comprising:
an operating system;
an Internet operating system comprising a binding of the virtualized storage resources with the virtualized web applications, wherein the virtualized web applications and the virtualized storage resources appear as nodes; and
at least one plug-in for implementing a generic interface between the user and the virtualized web applications;
a peer to peer high speed channel to all devices in the Internet operating system; and
a presentation medium for facilitating a user interaction between the virtualized web applications and the virtualized storage resources.

22. The system of claim 21 wherein the Internet operating system comprises an aggregation of the user's Internet, local storage and computing resources.

23. The system of claim 21 wherein the presentation medium is a physical desktop as part of the user's operating system.

24. The system of claim 21 wherein the presentation medium is a desktop environment embedded in a web browser.

25. The system of claim 21 wherein the presentation medium is a third party integration.

26. The system of claim 21 wherein the peer to peer high speed channel comprises a high speed TCP channel.

27. The system of claim 21 wherein the at least one plug-in is a tiered RAID storage device for multiple providers.
